(19) United States
(12) Patent Application Publication
(10) Pub. No.: US 2012/0050253 A1
(43) Pub. Date: Mar. 1, 2012

(54) METHOD FOR DRIVING PLASMA DISPLAY PANEL AND PLASMA DISPLAY DEVICE

(75) Inventors: Yuichi Sakai, Osaka (JP); Kenji Ogawa, Osaka (JP); Yutaka Yoshihama, Osaka (JP); Keiji Akamatsu, Hyogo (JP)

(73) Assignee: PANASONIC CORPORATION, Osaka (JP)

(21) Appl. No.: 13/262,684

(22) PCT Filed: May 13, 2010
(86) PCT No.: PCT/JP2010/003230

§ 371 Date: Oct. 3, 2011

(30) Foreign Application Priority Data
May 14, 2009 (JP) 2009-117464

(51) Int. Cl. G09G 3/28; G09G 5/00

(52) U.S. Cl. 345/212; 345/60

(57) ABSTRACT

An unnecessary discharge caused in the discharge cells in an initializing operation is prevented. This reduces the luminance of black level in a display image and stabilizes the address discharge at the same time, thus enhancing the image display quality. A plasma display panel that has a plurality of discharge cells having data electrodes and display electrode pairs, each formed of a scan electrode and a sustain electrode, is driven for gradation display such that a plurality of subfields is set in one field and each of the subfields has an initializing period, an address period, and a sustain period. For the above purpose, in the driving method for the plasma display panel, the following operations are performed. In the address period of a predetermined subfield, after the application of a scan pulse to all the scan electrodes is completed, a ramp voltage gently falling from a first voltage is applied to the sustain electrodes. In the period during which the falling ramp voltage is applied to the sustain electrodes, a second voltage is applied to the data electrodes.

### TECHNICAL FIELD

The present invention relates to a driving method for a plasma display panel, and a plasma display device that are used for a wall-mounted television or a large monitor.

### BACKGROUND ART

A typical alternating-current surface discharge panel used as a plasma display panel (hereinafter, simply referred to as “panel”) has a large number of discharge cells that are formed between a front plate and a rear plate facing each other. The front plate has the following elements:
a plurality of display electrode pairs, each formed of a pair of scan electrode and sustain electrode, disposed on a front glass substrate parallel to each other; and
a dielectric layer and a protective layer formed so as to cover the display electrode pairs. The rear plate has the following elements:
a plurality of parallel data electrodes formed on a rear glass substrate;
a dielectric layer formed so as to cover the data electrodes;
a plurality of barrier ribs formed on the dielectric layer parallel to the data electrodes; and
phosphor layers formed on the surface of the dielectric layer and on the side faces of the barrier ribs.

The front plate and the rear plate face each other such that the display electrode pairs and the data electrodes three-dimensionally intersect, and are sealed together. A discharge gas containing xenon in a partial pressure ratio of 5%, for example, is charged into the sealed inside discharge space. Discharge cells are formed in portions where the display electrode pairs face the data electrodes. In a panel having such a structure, gas discharge generates ultraviolet light in each discharge cell. This ultraviolet light excites the red (R), green (G), and blue (B) phosphors, so that the phosphors emit the respective colors for color display.

As a driving method for the panel, a subfield method is typically used. In the subfield method, one field is divided into a plurality of subfields, and light emission and no light emission in the respective discharge cells are controlled in the respective subfields. Then, the number of light emissions caused in one field is controlled for gradation display.

Each subfield has an initializing period, an address period, and a sustain period. In the initializing period, an initializing waveform is applied to the respective scan electrodes so as to cause an initializing discharge in the respective discharge cells. This initializing discharge forms wall charge necessary for the subsequent address operation in the respective discharge cells and generates priming particles (excitation particles for causing an address discharge) for causing the address discharge stably.

In the address period, a scan pulse is sequentially applied to the scan electrodes, and an address pulse corresponding to a signal of an image to be displayed is selectively applied to the data electrodes. Thereby, an address discharge is caused between the scan electrodes and the data electrodes so as to form wall charge in the discharge cells to be lit (hereinafter, this operation being also referred to as “addressing”).

In the sustain period, a sustain pulse is alternately applied to display electrode pairs, each formed of a scan electrode and a sustain electrode, at a number of times predetermined for each subfield. Thereby, a sustain discharge is caused in the discharge cells where the address discharge has formed wall charge, and thus the phosphor layers in the discharge cells emit light. In this manner, an image is displayed in the image display area of the panel.

One of important factors in enhancing image display quality in a panel is to enhance contrast. As one of the subfield methods, a driving method for minimizing the light emission unrelated to gradation display so as to enhance the contrast ratio is disclosed.

In this driving method, the following operations are performed. In the initializing period of one subfield among a plurality of subfields forming one field, an initializing operation for causing an initializing discharge in all the discharge cells is performed. In the initializing periods of the other subfields, an initializing operation for causing an initializing discharge selectively in the discharge cells having undergone a sustain discharge in the immediately preceding sustain period is performed.

Luminance in an area displaying a black picture (hereinafter, simply referred to as “luminance of black level”) where no sustain discharge occurs is changed by the light emission unrelated to image display. Examples of such light emission include a light emission caused by the initializing discharge. In the above driving method, the light emission in the area displaying a black picture is only a weak light emission caused when an initializing operation is performed on all the discharge cells. This method can reduce the luminance of black level and thus allows the display of an image having a high contrast (see Patent Literature 1, for example).

In recent years, with an increase in the screen size and definition of a panel, it has been requested to further enhance the image display quality.

For this purpose, for example, the following attempt is made. That is, the maximum voltage of the initializing waveform in the initializing operation for causing an initializing discharge in all the discharge cells is lowered so as to reduce the emission luminance in the initializing discharge and to further reduce the luminance of black level.

However, lowering the maximum voltage of the initializing waveform can shorten the duration of the initializing discharge, and thus hinder the formation of sufficient wall charge on the respective electrodes.

To address this problem, the following attempt is also made (see Patent Literature 2, for example). That is, when an initializing discharge is caused, a positive voltage is applied to the data electrodes. Thereby, before a discharge occurs between the scan electrodes and the data electrodes, a discharge is caused between the scan electrodes and the sustain electrodes. This causes the initializing discharge stably.

However, in the conventional art described in Patent Literature 2, when the positive voltage is applied to the data electrodes, an unnecessary discharge can occur between the sustain electrodes and the data electrodes. In such a case, the priming particles and wall charge in the discharge cells reduce, and thus the address discharge does not occur normally in some cases. Hereinafter, the phenomenon in which address discharge does not occur normally is also denoted as “addressing failure”.

### CITATION LIST

### Patent Literature

[PTL1]
Japanese Patent Unexamined Publication No. 2000-242224

[PTL2]
International Patent Publication No. 2008/018527

### SUMMARY OF THE INVENTION

In a driving method for a panel,
the panel having a plurality of discharge cells, each of the discharge cells having a display electrode pair and a data electrode, the display electrode pair having a scan electrode and a sustain electrode,
the panel displaying gradation in a manner such that a plurality of subfields is set in one field, and each of the subfields has an initializing period, an address period, and a sustain period,
in the initializing period, an initializing waveform being applied to the scan electrodes so as to cause an initializing discharge in the discharge cells,
in the address period, a scan pulse being applied to the scan electrodes, a first voltage being applied to the sustain electrodes, and an address pulse being selectively applied to the data electrodes so as to cause an address discharge in the discharge cells to be lit,
in the sustain period, sustain pulses being alternately applied to the display electrode pairs so as to cause a sustain discharge in the discharge cells having undergone the address discharge,
the driving method includes:
   applying a ramp voltage gently falling from the first voltage to the sustain electrodes in a predetermined one of the subfields, after the application of the scan pulse to all the scan electrodes is completed and before the sustain pulses are applied to the display electrode pairs; and
   applying a second voltage to the data electrodes in the period during which the falling ramp voltage is applied to the sustain electrodes.

This method prevents an unnecessary discharge in the discharge cells caused when an initializing operation is performed with a positive voltage applied to the data electrodes. This method can reduce the luminance of black level of the display image and stabilize the address discharge at the same time, thus enhancing the image display quality.

### BRIEF DESCRIPTION OF DRAWINGS

FIG. 1 is an exploded perspective view showing a structure of a panel in accordance with a first exemplary embodiment of the present invention.

FIG. 2 is an electrode array diagram of the panel in accordance with the first exemplary embodiment.

FIG. 3 is a waveform chart showing an example of driving voltage waveforms applied to the respective electrodes of the panel in accordance with the first exemplary embodiment.

FIG. 4 is a circuit block diagram of a plasma display device in accordance with the first exemplary embodiment.

FIG. 5 is a circuit diagram showing a configuration example of a scan electrode driving circuit of the plasma display device in accordance with the first exemplary embodiment.

FIG. 6 is a circuit diagram showing a configuration example of a sustain electrode driving circuit of the plasma display device in accordance with the first exemplary embodiment.

FIG. 7 is a circuit diagram showing a configuration example of a data electrode driving circuit of the plasma display device in accordance with the first exemplary embodiment.

FIG. 8 is a timing chart for explaining an example of the operation of the scan electrode driving circuit in the initializing period of a specified-cell initializing subfield in accordance with the first exemplary embodiment.

FIG. 9 is a chart showing an example of the pattern of forced initializing waveforms and non-initializing waveforms in accordance with the first exemplary embodiment.

FIG. 10 is a waveform chart showing an example of driving voltage waveforms applied to the respective electrodes of the panel in accordance with a second exemplary embodiment of the present invention.

FIG. 11 is a circuit diagram showing a configuration example of a sustain electrode driving circuit of the plasma display device in accordance with the second exemplary embodiment.

FIG. 12 is a waveform chart showing an example of driving voltage waveforms applied to the respective electrodes of the panel in accordance with a third exemplary embodiment of the present invention.

FIG. 13 is a waveform chart showing another example of driving voltage waveforms applied to the respective electrodes of the panel in accordance with the third exemplary embodiment.

FIG. 14 is a waveform chart showing still another example of driving voltage waveforms applied to the respective electrodes of the panel in accordance with the third exemplary embodiment.

### DETAILED DESCRIPTION OF PREFERRED EMBODIMENTS

Hereinafter, a plasma display device in accordance with exemplary embodiments of the present invention will be described, with reference to the accompanying drawings.

### First Exemplary Embodiment

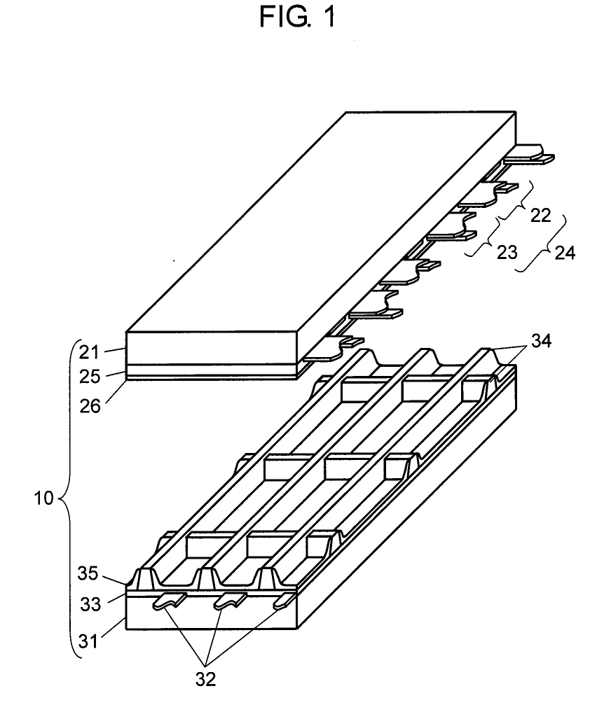

FIG. 1 is an exploded perspective view showing a structure of panel 10 in accordance with the first exemplary embodiment of the present invention. A plurality of display electrode pairs 24, each formed of scan electrode 22 and sustain electrode 23, is disposed on glass front plate 21. Dielectric layer 25 is formed so as to cover scan electrodes 22 and sustain electrodes 23. Protective layer 26 is formed over dielectric layer 25. Protective layer 26 is made of a material predominantly composed of magnesium oxide (MgO). MgO has a high secondary electron emission coefficient and excellent durability.

A plurality of data electrodes 32 is formed on rear plate 31. Dielectric layer 33 is formed so as to cover data electrodes 32, and mesh barrier ribs 34 are formed on the dielectric layer. On the side faces of barrier ribs 34 and on dielectric layer 33, phosphor layers 35 for emitting light in respective red (R), green (G), and blue (B) colors are formed.

Front plate 21 and rear plate 31 face each other such that display electrode pairs 24 intersect with data electrodes 32 with a small discharge space sandwiched between the electrodes. The outer peripheries of the plates are sealed with a sealing material, such as a glass frit. In the inside discharge space, a mixed gas of neon and xenon is sealed as a discharge gas. In this exemplary embodiment, a discharge gas having a xenon partial pressure of approximately 10% is used to improve the emission efficiency. The discharge space is partitioned into a plurality of compartments by barrier ribs 34. Discharge cells are formed in the intersecting parts of display electrode pairs 24 and data electrodes 32. The discharge cells discharge and emit light so as to display an image.

The structure of panel 10 is not limited to the above, and may include barrier ribs formed in a stripe pattern, for example. The mixing ratio of the discharge gas is not limited to the above numerical value, and other mixing ratios may be used.

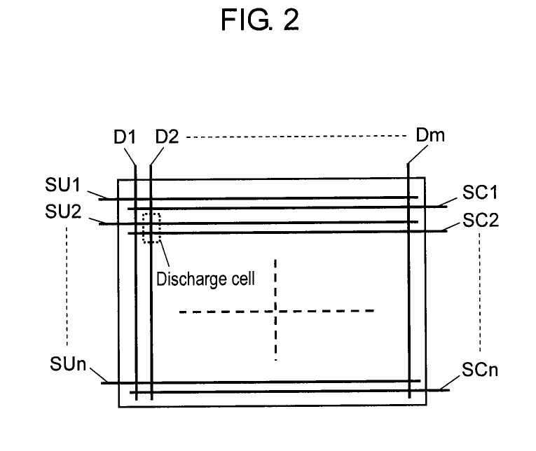

FIG. 2 is an electrode array diagram of panel 10 in accordance with the first exemplary embodiment of the present invention. Panel 10 has n scan electrode SC1 through scan electrode SCn (scan electrodes 22 in FIG. 1) and n sustain electrode SU1 through sustain electrode SUn (sustain electrodes 23 in FIG. 1) both long in the row direction, and m data electrode D1 through data electrode Dm (data electrodes 32 in FIG. 1) long in the column direction. A discharge cell is formed in the part where a pair of scan electrode SCi (i being 1 through n) and sustain electrode SUi intersects with one data electrode Dk (k being 1 through m). Thus, m×n discharge cells are formed in the discharge space. The area where m×n discharge cells are formed is the display area of panel 10.

Next, driving voltage waveforms for driving panel 10 and the operation thereof are outlined. In a plasma display device in this exemplary embodiment, panel 10 is driven by a subfield method. In this subfield method, one field is divided into a plurality of subfields along a temporal axis, a luminance weight is set for each subfield, and light emission or no light emission in each discharge cell is controlled in each subfield for gradation display.

In this subfield (SF) method, one field is formed of eight subfields (the first SF, and the second SF through the eighth SF), and the respective subfields have luminance weights of 1, 2, 4, 8, 16, 32, 64, and 128, for example. In the sustain period of each subfield, sustain pulses equal in number to the luminance weight of the subfield multiplied by a predetermined luminance magnification are applied to respective display electrode pairs 24.

In this exemplary embodiment, in the initializing periods, any one of a plurality of initializing operations including “forced initializing operation” is performed selectively. The plurality of initializing operations includes “forced initializing operation”, “non-initializing operation”, and “selective initializing operation”. In the initializing period of one subfield among the plurality of subfields, an initializing operation for selectively performing a “forced initializing operation” and a “non-initializing operation” is performed. In the initializing periods of the other subfields, a “selective initializing operation” is performed. These operations can minimize the light emission unrelated to gradation display, thus enhancing the contrast ratio. The “forced initializing operation” is an initializing operation for causing an initializing discharge in the discharge cells regardless of the operation in the immediately preceding subfield by applying a forced initializing waveform to be described later to scan electrodes 22. The “non-initializing operation” is an initializing operation for causing an initializing discharge with up-ramp voltage L1 to be described later in no discharge cells. The “selective initializing operation” is an initializing operation for causing an initializing discharge only in the discharge cells having undergone a sustain discharge in the sustain period of the immediately preceding subfield. Hereinafter, the initializing operation for selectively performing a forced initializing operation and a non-initializing operation in the initializing period of one subfield is referred to as “specified-cell initializing operation”. A subfield where the specified-cell initializing operation is performed in the initializing period is referred to as “specified-cell initializing subfield”. A subfield where the selective initializing operation is performed in the initializing period is referred to as “selective initializing subfield”.

In the structure of this exemplary embodiment, in addition to the above specified-cell initializing subfield and selective initializing subfield, a non-initializing subfield where a non-initializing operation is performed on all the discharge cells in the initializing period is set. That is, the non-initializing subfield is a subfield where an initializing discharge with up-ramp voltage L1 to be described later is caused in no discharge cells.

In this exemplary embodiment, one field is formed of eight subfields (the first SF, and the second SF through the eighth SF). The first SF is either a specified-cell initializing subfield or a non-initializing subfield. Each of the second SF through the eight SF is a selective initializing subfield. Further, the discharge cells for undergoing a forced initializing operation are changed in each field such that the frequency of forced initializing operations performed on each discharge cell is once in a plurality of fields. In this exemplary embodiment, a description is provided for an example where the frequency of forced initializing operations performed on each discharge cell is once every six fields.

With this structure, the frequency of forced initializing operations performed on each discharge cell is once in a plurality of fields. In the example of this exemplary embodiment, this frequency is once every six fields. Thus, the frequency of forced initializing operations can be reduced when compared with that in a structure where forced initializing operations are performed once every field. The luminance of black level, i.e. the luminance of an area displaying a black picture where no sustain discharge occurs, changes with the frequency of forced initializing operations. Thus, reducing the frequency of forced initializing operations can reduce the luminance of black level in a display image, thus enhancing the contrast.

Hereinafter, a field that has a specified-cell initializing subfield (e.g. the first SF) and a plurality of selective initializing subfields (e.g. the second SF through the eighth SF) is referred to as “specified-cell initializing field”. A field that has a non-initializing subfield (e.g. the first SF) and a plurality of selective initializing subfields (e.g. the second SF through the eighth SF) is referred to as “non-initializing field”.

However, in this exemplary embodiment, the number of subfields, or the luminance weight of each subfield is not limited to the above values. The subfield structure may be switched on the basis of image signals, for example.

Next, a description is provided for driving voltage waveforms in a specified-cell initializing field as an example.

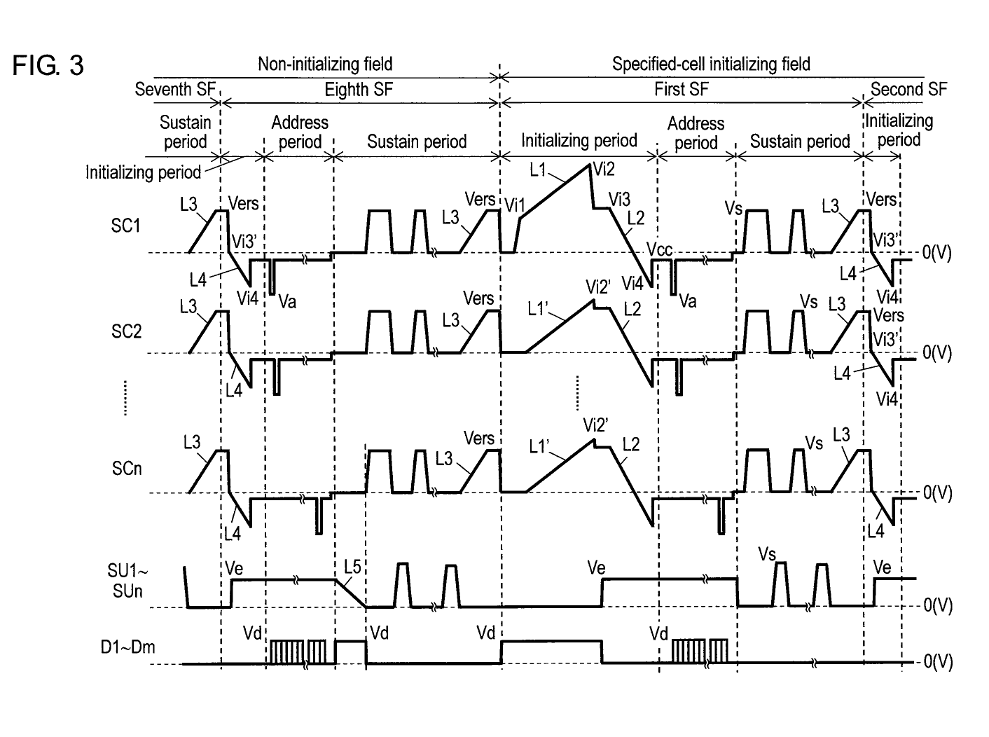

FIG. 3 is a waveform chart showing an example of driving voltage waveforms applied to the respective electrodes of panel 10 in accordance with the first exemplary embodiment of the present invention. FIG. 3 shows driving voltage waveforms applied to the following electrodes: scan electrode SC1 for undergoing an address operation first in the address periods; scan electrode SC2 for undergoing an address operation second in the address periods; scan electrode SCn for undergoing an address operation last in the address periods (e.g. scan electrode SC1080); sustain electrode SU1 through sustain electrode SUn; and data electrode D1 through data electrode Dm.

FIG. 3 shows driving voltage waveforms in two subfields: the last subfield (eight SF) of a non-initializing field; and the first subfield (first SF) of a specified-cell initializing field. In this exemplary embodiment, the first SF of the specified-cell initializing field is a specified-cell initializing subfield. The subfields in the specified-cell initializing field and the non-initializing field other than the first SFs are selective initializing subfields.

Scan electrode SCi, sustain electrode SUi, and data electrode Dk in the following description show the electrodes selected among the respective electrodes based on subfield data. This subfield data is data showing light emission and no light emission in each subfield.

FIG. 3 shows an example where a forced initializing waveform is applied to scan electrodes SC(1+3×N) in the (1+3×N)-th positions (N being integers) from the top, and a non-initializing waveform is applied to scan electrodes 22 other than electrodes SC(1+3×N). The forced initializing waveform is an initializing waveform for a forced initializing operation, i.e. an initializing waveform for causing an initializing discharge in the discharge cells regardless of the operation in the immediately preceding subfield. The non-initializing waveform is a waveform for a non-initializing operation, i.e. an initializing waveform for causing an initializing discharge with up-ramp voltage L1 to be described later in no discharge cells.

First, a description is provided for the first SF, a specified-cell initializing subfield.

In the first half of the initializing period of the first SF, 0 (V) is applied to sustain electrode SU1 through sustain electrode SUn, and positive voltage Vd, i.e. a third voltage, is applied to data electrode D1 through data electrode Dm. To scan electrodes SC(1+3×N), voltage Vi1, and a ramp voltage (hereinafter, referred to as “up-ramp voltage L1”) that rises from voltage Vi1 toward voltage Vi2 gently (with a gradient of approximately 0.5 V/μsec, for example) are applied. At this time, voltage Vi1 is a voltage lower than a breakdown voltage with respect to sustain electrodes SU(1+3×N), and voltage Vi2 is a voltage exceeding the breakdown voltage with respect to sustain electrodes SU(1+3×N).

While this up-ramp voltage L1 is rising, a weak initializing discharge continuously occurs between scan electrodes SC(1+3×N) and sustain electrodes SU(1+3×N), and between scan electrodes SC(1+3×N) and data electrode D1 through data electrode Dm. Then, negative wall voltage accumulates on scan electrodes SC(1+3×N); positive wall voltage accumulates on data electrode D1 through data electrode Dm intersecting with scan electrodes SC(1+3×N), and on sustain electrodes SU(1+3×N). Here, this wall voltage on the electrodes means the voltage generated by the wall charge that is accumulated on the dielectric layers covering the electrodes, the protective layer, the phosphor layers, or the like.

In the second half of the initializing period, the voltage applied to scan electrodes SC(1+3×N) is dropped from voltage Vi2 to voltage Vi3, which is lower than voltage Vi2. Positive voltage Ve is applied to sustain electrode SU1 through sustain electrode SUn and 0 (V) is applied to data electrode D1 through data electrode Dm. To scan electrodes SC(1+3×N), a ramp voltage (hereinafter, referred to as “down-ramp voltage L2”) that falls from voltage Vi3 toward negative voltage Vi4 gently (with a gradient of approximately −0.5 V/μsec, for example) is applied. At this time, voltage Vi3 is a voltage lower than the breakdown voltage with respect to sustain electrodes SU(1+3×N), and voltage Vi4 is a voltage exceeding the breakdown voltage with respect to sustain electrodes SU(1+3×N).

During this application, a weak initializing discharge occurs between scan electrodes SC(1+3×N) and sustain electrodes SU(1+3×N), and between scan electrodes SC(1+3×N) and data electrode D1 through data electrode Dm. This weak discharge reduces the negative wall voltage on scan electrodes SC(1+3×N), and the positive wall voltage on sustain electrodes SU(1+3×N), and adjusts the positive wall voltage on data electrode D1 through data electrode Dm intersecting with scan electrodes SC(1+3×N) to a value appropriate for the address operation.

The above waveform is the forced initializing waveform for causing an initializing discharge in the discharge cells regardless of the operation in the immediately preceding subfield. The above operation of applying the forced initializing waveform to scan electrodes 22 is the forced initializing operation.

On the other hand, the following operations are performed on scan electrodes 22 other than scan electrodes SC(1+3×N). That is, in the first half of the initializing period of the first SF, instead of application of voltage Vi1, 0 (V) is kept, and up-ramp voltage L1′, which gently rises from 0 (V) toward voltage Vi2′, is applied to the above electrodes. Here, this up-ramp voltage L1′ continues to rise with a gradient equal to that of up-ramp voltage L1 for a period equal to that of up-ramp voltage L1. Therefore, voltage Vi2′ is equal to the voltage obtained by subtracting voltage Vi1 from voltage Vi2. At this time, each voltage and up-ramp voltage L1′ are set such that voltage Vi2′ is lower than the breakdown voltage with respect to sustain electrodes 23. With this setting, the discharge to be caused by the application of up-ramp voltage L1 substantially does not occur in the discharge cells applied with up-ramp voltage L1′.

In the second half of the initializing period, down-ramp voltage L2 is also applied to scan electrodes 22 other than scan electrodes SC(1+3×N), in a manner similar to that of scan electrodes SC(1+3×N).

The above waveform is the non-initializing waveform. The above operation of applying the non-initializing waveform to scan electrodes 22 is the non-initializing operation.

In the forced initializing operation, the duration of the initializing discharge changes with the magnitude of voltage Vi2, i.e. the maximum voltage of up-ramp voltage L1. Thus, lowering voltage Vi2 can shorten the duration of the initializing discharge. Since the luminance of black level changes with the light emission caused by the forced initializing operation, shortening the duration of the initializing discharge can reduce the light emission in the forced initializing operation, thus further reducing the luminance of black level.

However, shortening the duration of the initializing discharge reduces the wall charge and the amount of priming particles formed by the initializing discharge. Then, in some discharge cells, the forced initializing operation in the next specified-cell initializing field is performed with insufficient wall charge and priming particles. In such discharge cells, a discharge is forced to occur with insufficient wall charge and priming particles and thus a strong discharge occurs in the forced initializing operation.

Such a strong discharge is considered to occur for the following reason.

As described above, the top portions of scan electrodes 22 and sustain electrodes 23 are covered with protective layer 26. The protective layer is made of a material that is predominantly composed of MgO, which has a high secondary electron emission coefficient. On the other hand, the top portions of data electrodes 32 are covered with phosphor layer 35, which has a secondary electron emission coefficient lower than that of protective layer 26. Thus, in the initializing operation, the initializing discharge can be stabilized by causing a discharge between scan electrodes 22 and sustain electrodes 23 earlier than between scan electrodes 22 and data electrodes 32.

However, lowering voltage Vi2 makes the potential difference between scan electrodes 22 and sustain electrodes 23 smaller than that when voltage Vi2 is high. Thus, it is highly possible that a discharge occurs between scan electrodes 22 and data electrodes 32 earlier than between scan electrodes 22 and sustain electrodes 23. At this time, when the wall charge and priming particles are insufficient, a discharge is forced to occur and thus a strong discharge occurs.

It is verified that, in the discharge cells where a strong discharge occurs in the application of up-ramp voltage L1, a similar strong discharge is likely to occur also in the application of down-ramp voltage L2. The state of the wall charge in a discharge cell where such a strong discharge has occurred can be similar to that of a discharge cell having undergone addressing. In such a case, in the discharge cell, a sustain discharge occurs regardless of whether an address operation is performed or not. Hereinafter, the light emission of the sustain discharge in the discharge cell caused by such a phenomenon regardless of whether an address operation is performed or not is referred to as “initializing bright spot”.

The wall charge and priming particles reduce with a lapse of time. Thus, in a structure where the forced initializing operations are performed on each discharge cell at a frequency of only once in a plurality of fields, the increased interval of forced initializing operations makes wall charge and priming particles less sufficient than those in a structure where the forced initializing operations are performed at a frequency of once every field. Therefore, when a panel is driven in the former structure, a strong discharge and thus an initializing bright spot are likely to occur.

As described above, it is considered that this strong discharge results from a discharge occurring between scan electrodes 22 and data electrodes 32 earlier than between scan electrodes 22 and sustain electrodes 23. Thus, when a discharge can be caused between scan electrodes 22 and sustain electrodes 23 earlier than between scan electrodes 22 and data electrodes 32, the occurrence of a strong discharge can be suppressed.

For this purpose, as shown in FIG. 3, in the period during which up-ramp voltage L1 is applied to scan electrodes 22, positive voltage Vd is applied to data electrodes 32. This application reduces the potential difference between scan electrodes 22 and data electrodes 32 by voltage Vd, and makes it easier to cause a discharge between scan electrodes 22 and sustain electrodes 23 earlier than between scan electrodes 22 and data electrodes 32. Thus, the occurrence of a strong discharge can be suppressed.

When priming particles remaining in discharge cells are insufficient, an initializing discharge cannot be caused even by the application of up-ramp voltage L1 to scan electrodes 22 in some cases. In the discharge cell where no initializing discharge occurs, addressing failure is caused by the lack of wall charge in the subsequent addressing, and no sustain discharge occurs. Hereinafter, a discharge cell where no sustain discharge occurs regardless of whether an address operation is performed or not is referred to as “unlit cell”. However, the application of positive voltage Vd to data electrodes 32 during the application of up-ramp voltage L1 can cause an initializing discharge stably, thus preventing the occurrence of the unlit cell.

The forced initializing waveform in the present invention is not limited to the above waveform. Any waveform may be used as long as the waveform causes an initializing discharge in the discharge cells regardless of the operation in the immediately preceding subfield. The non-initializing waveform in the present invention is not limited to the above waveform. The non-initializing waveform in this exemplary embodiment only shows an example of the waveform for causing no initializing discharge in the discharge cells in the first half of the initializing period. Any waveform, e.g. a waveform for clamping the voltage in the first half of the initializing period to 0 (V), may be used as long as the waveform causes no initializing discharge in the first half of the initializing period.

In this manner, the specified-cell initializing operation in the initializing period of the specified-cell initializing subfield is completed. That is, the forced initializing waveform is applied to predetermined ones (e.g. scan electrodes SC(1+3×N)) of scan electrodes 22 and the non-initializing waveform is applied to the other ones of scan electrodes 22, for the forced initializing operation in the specified discharge cells and the non-initializing operation in the other discharge cells.

In the subsequent address period, scan pulse voltage Va is sequentially applied to scan electrode SC1 through scan electrode SCn, and positive address pulse voltage Vd is applied to data electrode Dk (k being 1 through m) corresponding to a discharge cell to be lit among data electrode D1 through data electrode Dm. Thus, an address discharge is caused selectively in the respective discharge cells.

Specifically, first, positive voltage Ve, i.e. a first voltage, is applied to sustain electrode SU1 through sustain electrode SUn, and voltage Vcc is applied to scan electrode SC1 through scan electrode SCn.

Next, negative scan pulse voltage Va is applied to scan electrode SC1 in the first position (the first row) from the top, and positive address pulse voltage Vd is applied to data electrode Dk (k being 1 through m) of the discharge cell to be lit in the first row among data electrode D1 through data electrode Dm. At this time, the voltage difference in the intersecting part of data electrode Dk and scan electrode SC1 is obtained by adding the difference between the wall voltage on data electrode Dk and the wall voltage on scan electrode SC1 to a difference in externally applied voltage (voltage Vd-voltage Va). Thus, the voltage difference exceeds the breakdown voltage. Then, a discharge occurs between data electrodes Dk and scan electrode SC1.

Since voltage Ve is applied to sustain electrode SU1 through sustain electrode SUn, the voltage difference between sustain electrode SU1 and scan electrode SC1 is obtained by adding the difference between the wall voltage on sustain electrode SU1 and the wall voltage on scan electrode SC1 to a difference in externally applied voltage (voltage Ve-voltage Va). At this time, setting voltage Ve to a value slightly lower than the breakdown voltage can make a state where a discharge is likely to occur but does not actually occur between sustain electrode SU1 and scan electrode SC1. With this setting, the discharge caused between data electrode Dk and scan electrode SC1 can trigger a discharge between the areas of sustain electrode SU1 and scan electrode SC1 intersecting with data electrode Dk.

Thus, an address discharge occurs in the discharge cells to be lit. Positive wall voltage accumulates on scan electrode SC1 and negative wall voltage accumulates on sustain electrode SU1. Negative wall voltage also accumulates on data electrode Dk.

In this manner, the address discharge is caused in the discharge cells to be lit in the first row so as to accumulate wall voltages on the respective electrodes. On the other hand, the voltage in the intersecting parts of scan electrode SC1 and data electrode D1 through data electrode Dm applied with no address pulse voltage Vd does not exceed the breakdown voltage, and thus no address discharge occurs. The above address operation is sequentially performed until the operation reaches the discharge cells in the n-th row, and the address period is completed.

In the subsequent sustain period, sustain pulses equal in number to the luminance weight multiplied by a predetermined luminance magnification are alternately applied to display electrode pairs 24. This application causes a sustain discharge in the discharge cells having undergone an address discharge, and causes the discharge cells to emit light.

Specifically, first, positive sustain pulse voltage Vs is applied to scan electrode SC1 through scan electrode SCn, and a ground potential as a base potential, i.e. 0 (V), is applied to sustain electrode SU1 through sustain electrode SUn. Then, in the discharge cells having undergone an address discharge, the voltage difference between scan electrode SCi and sustain electrode SUi is obtained by adding the difference between the wall voltage on scan electrode SCi and the wall voltage on sustain electrode SUi to sustain pulse voltage Vs. Thus, the voltage difference exceeds the breakdown voltage.

Then, a sustain discharge occurs between scan electrode SCi and sustain electrode SUi, and ultraviolet light generated at this time causes phosphor layers 35 to emit light. Thus, negative wall voltage accumulates on scan electrode SCi, and positive wall voltage accumulates on sustain electrode SUi. Positive wall voltage also accumulates on data electrode Dk. In the discharge cells having undergone no address discharge in the address period, no sustain discharge occurs.

Subsequently, 0 (V) as the base potential is applied to scan electrode SC1 through scan electrode SCn, and sustain pulse voltage Vs is applied to sustain electrode SU1 through sustain electrode SUn. In the discharge cell having undergone a sustain discharge, the voltage difference between sustain electrode SUi and scan electrode SCi exceeds the breakdown voltage. Thereby, a sustain discharge occurs between sustain electrode SUi and scan electrode SCi again. Thus, negative wall voltage accumulates on sustain electrode SUi, and positive wall voltage accumulates on scan electrode SCi. Similarly, sustain pulses equal in number to the luminance weight multiplied by the luminance magnification are alternately applied to scan electrode SC1 through scan electrode SCn and sustain electrode SU1 through sustain electrode SUn so as to cause a potential difference between the electrodes of display electrode pairs 24. Thereby, the sustain discharge is continued in the discharge cells having undergone an address discharge in the address period.

After the sustain pulses have been generated in the sustain period, a ramp voltage (hereinafter, referred to as “erasing ramp voltage L3”) is applied to scan electrode SC1 through scan electrode SCn while 0 (V) is applied to sustain electrode SU1 through sustain electrode SUn and data electrode D1 through data electrode Dm. Here, erasing ramp voltage L3 rises gently (with a gradient of approximately 10 V/μsec, for example) from 0 (V) toward voltage Vers, which exceeds the breakdown voltage. Thereby, between sustain electrode SUi and scan electrode SCi in the discharge cell having undergone a sustain discharge, a weak discharge continuously occurs. The charged particles generated by this weak discharge accumulate on sustain electrode SUi and scan electrode SCi, as wall charge, so as to reduce the voltage difference between sustain electrode SUi and scan electrode SCi. With this operation, the wall voltage on scan electrode SCi and the wall voltage on sustain electrode SUi are reduced to the difference between the voltage applied to scan electrode SCi and the breakdown voltage, e.g. a level of (voltage Vers-breakdown voltage), while the positive wall voltage is left on data electrode Dk.

Thereafter, the voltage applied to scan electrode SC1 through scan electrode SCn is returned to 0 (V), and the sustain operation in the sustain period is completed.

Next, the second SF, a selective initializing subfield, is described.

In the initializing period of the second SF, a selective initializing waveform is applied to all scan electrodes 22. The selective initializing waveform in this exemplary embodiment is a driving voltage waveform where the first half of the forced initializing waveform is omitted. Specifically, voltage Ve is applied to sustain electrode SU1 through sustain electrode SUn, 0 (V) is applied to data electrode D1 through data electrode Dm, and down-ramp voltage L4 is applied to scan electrode SC1 through scan electrode SCn. Here, down-ramp voltage L4 falls from a voltage lower than the breakdown voltage (e.g. 0 (V)) toward negative voltage Vi4 with a gradient equal to that of down-ramp voltage L2.

Thus, a weak initializing discharge occurs in the discharge cells having undergone a sustain discharge in the sustain period of the immediately preceding subfield (the first SF in FIG. 3). This reduces the wall voltages on scan electrode SCi and sustain electrode SUi, and adjust the wall voltage on data electrode Dk (k being 1 through m) to a value appropriate for the address operation.

The above waveform is the selective initializing waveform for causing an initializing discharge only in the discharge cells having undergone a sustain discharge in the sustain period of the immediately preceding subfield. The above operation of applying the selective initializing waveform to all scan electrodes 22 is the selective initializing operation.

In this manner, the selective initializing operation in the initializing period of the selective initializing subfield is completed.

The selective initializing waveform of the present invention is not limited to the above waveform. Any waveform may be used as long as the waveform causes an initializing discharge only in the discharge cells having undergone a sustain discharge in the sustain period of the immediately preceding subfield. For example, in this exemplary embodiment, a description is provided for a structure where down ramp voltage L4 is generated with the same gradient. However, down-ramp voltage L4 may be divided for a plurality of sub-periods and generated with gradients different in the respective sub-periods.

In the address period of the second SF, the driving voltage waveforms identical to those in the address period of the first SF are applied to the respective electrodes. In the sustain period of the second SF, the driving voltage waveforms identical to those in the sustain period of the first SF except for the number of sustain pulses are applied to the respective electrodes.

In the third SF and the subfields thereafter, the driving voltage waveforms identical to those in the second SF except for the number of sustain pulses in the sustain period are applied to the respective electrodes.

Setting voltage Vd to a higher value can stabilize the initializing operation caused by the application of up-ramp voltage L1 to scan electrodes 22, and enhance the advantage of preventing the occurrence of initializing bright spots and unlit cells. For this purpose, it is preferable to set voltage Vd to a value as high as possible.

However, when voltage Vd set to a higher value is applied, an unnecessary discharge can occur in the discharge cells. At voltage Vd set to a higher value, this unnecessary discharge occurs with a higher possibility.

This unnecessary discharge considerably reduces the wall charge remaining in the discharge cells. Further, a forced initializing operation is not performed on the discharge cells for undergoing a non-initializing operation (in the example in FIG. 3, discharge cells on scan electrode SC2 and scan electrode SCn, for example). Thus, the above wall charge may be used for the subsequent address operation without being initialized. Therefore, if this unnecessary discharge occurs in a discharge cell for undergoing a non-initializing operation, the subsequent address operation (e.g. an address operation in the address period of the first SF) is performed with the wall charge necessary for the address operation considerably reduced. Thus, an address operation is performed on the discharge cell with insufficient wall charge, which can cause addressing failure and lead to an unlit cell.

Thus, in this exemplary embodiment, in order to prevent the unnecessary discharge caused in the application of voltage Vd to data electrodes 32, a weak discharge is caused between sustain electrodes 23 and data electrodes 32 in a predetermined subfield, i.e. the subfield immediately preceding the subfield where a forced initializing operation is to be performed by up-ramp voltage L1.

Specifically, in the subfield (the eighth SF in this exemplary embodiment) immediately preceding a specified-cell initializing subfield (the first SF in this exemplary embodiment), the following operations are performed. That is, after the application of scan pulses to all scan electrodes 22 is completed and before the sustain pulses are applied to display electrode pairs 24, 0 (V) is applied to scan electrode SC1 through scan electrode SCn, and down-ramp voltage L5 is applied to sustain electrode SU1 through sustain electrode SUn. Here, down-ramp voltage L5 falls gently (with a gradient of approximately −2.5 V/μsec, for example), from positive voltage Ve as the first voltage to the ground potential as the base potential. Further, in the period during which down-ramp voltage L5 is applied to sustain electrode SU1 through sustain electrode SUn, positive voltage Vd, i.e. a second voltage, is applied to data electrode D1 through data electrode Dm.

This causes a weak discharge between sustain electrode SU1 through sustain electrode SUn and data electrode D1 through data electrode Dm. Then, negative wall voltage accumulates on data electrode D1 through data electrode Dm so as to cancel out the potential difference between sustain electrode SU1 through sustain electrode SUn and data electrode D1 through data electrode Dm.

Therefore, when voltage Vd is applied to data electrode D1 through data electrode Dm in the initializing period of the subsequent specified-cell initializing subfield, the voltage on data electrode D1 through data electrode Dm is reduced by the negative wall voltage accumulating thereon. This can suppress the unnecessary discharge to be caused in the application of voltage Vd to data electrode D1 through data electrode Dm.

The above description has outlined the driving voltage waveforms applied to the respective electrodes of panel 10 in this exemplary embodiment.

In this exemplary embodiment, a description is provided for a structure where the second voltage is equal to the third voltage (voltage Vd). However, the second voltage may be different from the third voltage.

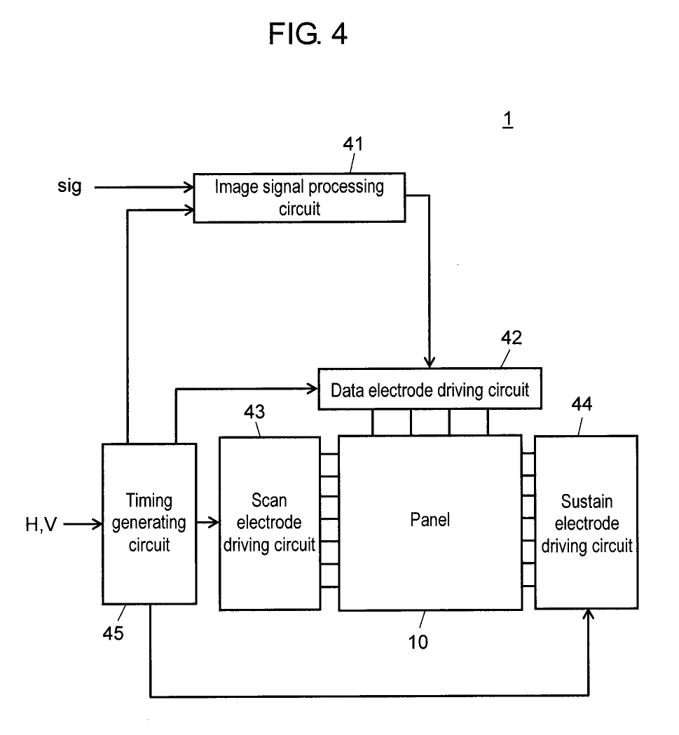

Next, the structure of a plasma display device in this exemplary embodiment is described. FIG. 4 is a circuit block diagram of plasma display device 1 in accordance with the first exemplary embodiment of the present invention. Plasma display device 1 has the following elements:
panel 10;
image signal processing circuit 41;
data electrode driving circuit 42;
scan electrode driving circuit 43;
sustain electrode driving circuit 44;
timing generating circuit 45; and
power supply circuits (not shown) for supplying power necessary for each circuit block.

Image signal processing circuit 41 converts input image signal sig into subfield data showing light emission or no light emission in each subfield, based on the number of pixels in panel 10.

Timing generating circuit 45 generates various timing signals for controlling the operation of each circuit block, based on horizontal synchronizing signal H and vertical synchronizing signal V, and supplies the timing signals to the respective circuit blocks (image signal processing circuit 41, data electrode driving circuit 42, scan electrode driving circuit 43, and sustain electrode driving circuit 44).

Data electrode driving circuit 42 converts subfield data in each subfield into signals corresponding to each of data electrode D1 through data electrode Dm, and drives each of data electrode D1 through data electrode Dm, in response to the timing signals supplied from timing generating circuit 45.

Scan electrode driving circuit 43 has the following elements:
an initializing waveform generating circuit for generating initializing waveforms to be applied to scan electrode SC1 through scan electrode SCn in the initializing periods;
a sustain pulse generating circuit for generating sustain pulses to be applied to scan electrode SC1 through scan electrode SCn in the sustain periods; and
a scan pulse generating circuit having a plurality of scan electrode driving integrated circuits (hereinafter, simply referred to as “scan ICs”), for generating a scan pulse to be applied to scan electrode SC1 through scan electrode SCn in the address periods. The scan electrode driving circuit drives each of scan electrode SC1 through scan electrode SCn, in response to the timing signals supplied from timing generating circuit 45.

Sustain electrode driving circuit 44 has a sustain pulse generating circuit and a circuit for generating voltage Ve, and drives sustain electrode SU1 through sustain electrode SUn, in response to the timing signals supplied from timing generating circuit 45.

Next, the details and operation of scan electrode driving circuit 43 are described.

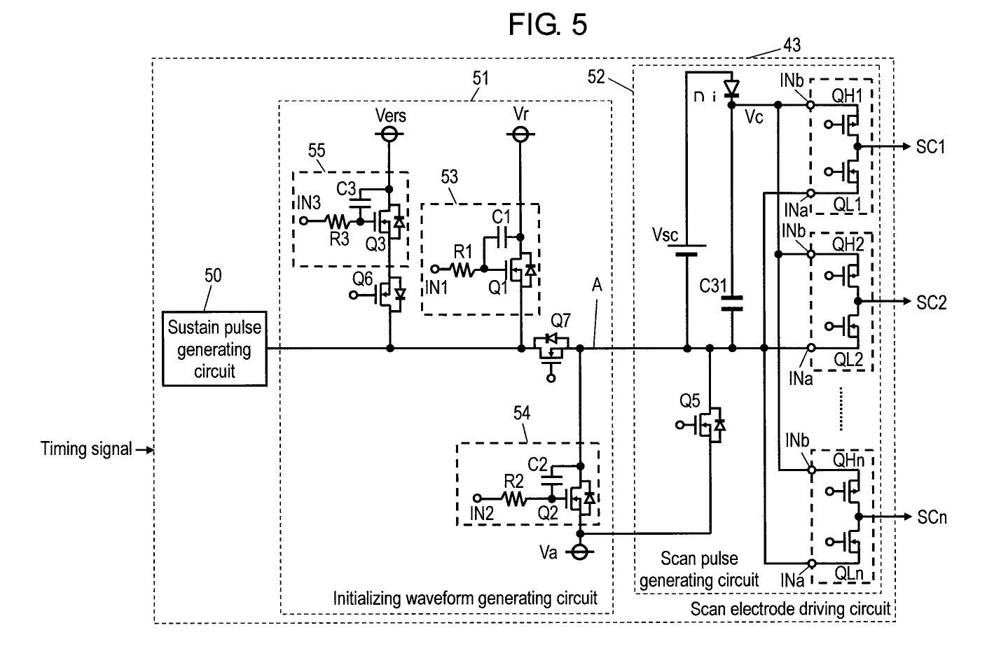

FIG. 5 is a circuit diagram showing a configuration example of scan electrode driving circuit 43 of plasma display device 1 in accordance with the first exemplary embodiment of the present invention. Scan electrode driving circuit 43 has the following elements:
sustain pulse generating circuit 50 for generating sustain pulses;
initializing waveform generating circuit 51 for generating initializing waveforms; and
scan pulse generating circuit 52 for generating scan pulses. The respective output terminals of scan pulse generating circuit 52 are connected to scan electrode SC1 through scan electrode SCn of panel 10. In this exemplary embodiment, the voltage input to scan pulse generating circuit 52 is denoted as “reference potential A”. In the following description, the operation of bringing a switching element into conduction is denoted as “ON”, and the operation of bringing a switching element out of conduction is denoted as “OFF”. A signal for setting a switching element to ON is denoted as “Hi”, and a signal for setting a switching element to OFF is denoted as “Lo”.

FIG. 5 shows a separating circuit using switching element Q7, for electrically separating sustain pulse generating circuit 50, a circuit based on voltage Vr (e.g. Miller integrating circuit 53), and a circuit based on voltage Vers (e.g. Miller integrating circuit 55) from a circuit based on negative voltage Va (e.g. Miller integrating circuit 54) while the latter circuit is operated. The diagram also shows a separating circuit using switching element Q6, for electrically separating a circuit based on voltage Vers (e.g. Miller integrating circuit 55), which is lower than voltage Vr, from a circuit based on voltage Vr (e.g. Miller integrating circuit 53) while the latter circuit is operated.

Sustain pulse generating circuit 50 has a generally-used power recovery circuit and clamp circuit, and generates sustain pulses by switching the respective switching elements included therein, in response to the timing signals output from timing generating circuit 45. In FIG. 5, the details of the paths of the timing signals are omitted.

Scan pulse generating circuit 52 has switching element QH1 through switching element QHn and switching element QL1 through switching element QLn for applying a scan pulse to n scan electrode SC1 through scan electrode SCn, respectively. One terminal of switching element QHj (j being 1 through n) is interconnected to one terminal of switching element QLj. The interconnected part forms an output terminal of scan pulse generating circuit 52 and is connected to scan electrode SCj.

The other terminal of switching element QHj is input terminal INb; the other terminal of switching element QLj is input terminal INa. Switching element QH1 through switching element QHn and switching element QL1 through switching element QLn are grouped in a plurality of outputs and formed into ICs. These ICs are scan ICs.

Scan pulse generating circuit 52 also has the following elements:
switching element Q5 for connecting reference potential A to negative voltage Va in the address periods; and
power supply VSC, diode Di31, and capacitor C31 for generating voltage Vc, where voltage Vsc is superimposed on reference potential A.
   Voltage Vc is connected to input terminal INb of each of switching element QH1 through switching element QHn; reference potential A is connected to input terminal INa of each of switching element QL1 through switching element QLn.

In scan pulse generating circuit 52 thus configured, in the address periods, switching element Q5 is set to ON so as to make reference potential A equal to negative voltage Va, and negative voltage Va is applied to input terminal INa. Further, voltage Vc (voltage Vcc in FIG. 3), i.e. voltage Va+voltage Vsc, is applied to input terminal INb. Then, based on subfield data, the following operations are performed. To scan electrode SCi to be applied with a scan pulse, negative scan pulse voltage Va is applied via switching element QLi, by setting switching element QHi to OFF and switching element QLi to ON. To scan electrode SCh to be applied with no scan pulse (h being 1 through n except i), voltage Va+voltage Vsc is applied via switching element QHh, by setting switching element QLh to OFF and switching element QHh to ON.

In the sustain periods, scan pulse generating circuit 52 is controlled by timing generating circuit 45 so as to output the voltage waveforms in sustain pulse generating circuit 50.

The details of the operation of scan pulse generating circuit 52 in the initializing periods will be described later.

Initializing waveform generating circuit 51 has Miller integrating circuit 53, Miller integrating circuit 54, and Miller integrating circuit 55. FIG. 5 shows the input terminal of Miller integrating circuit 53 as input terminal IN1, the input terminal of Miller integrating circuit 54 as input terminal IN2, and the input terminal of Miller integrating circuit 55 as input terminal IN3. Each of Miller integrating circuit 53 and Miller integrating circuit 55 is a ramp voltage generating circuit for generating a rising ramp voltage. Miller integrating circuit 54 is a ramp voltage generating circuit for generating a falling ramp voltage.

Miller integrating circuit 53 has switching element Q1, capacitor C1, and resistor R1. In the initializing operation, this Miller integrating circuit generates up-ramp voltage L1′, by causing reference potential A of scan electrode driving circuit 43 to rise to voltage Vi2′ gently (with a gradient of 0.5 V/μsec, for example) in a ramp form.

Miller integrating circuit 55 has switching element Q3, capacitor C3, and resistor R3. At the end of each sustain period, this Miller integrating circuit generates erasing ramp voltage L3, by causing reference potential A to rise to voltage Vers with a gradient (e.g. 10 V/μsec) steeper than that of up-ramp voltage L1.

Miller integrating circuit 54 has switching element Q2, capacitor C2, and resistor R2. In the initializing operation, this Miller integrating circuit generates down-ramp voltage L2 and down-ramp voltage L4, by causing reference potential A to fall to voltage Vi4 gently (with a gradient of −0.5 V/μsec, for example) in a ramp form.

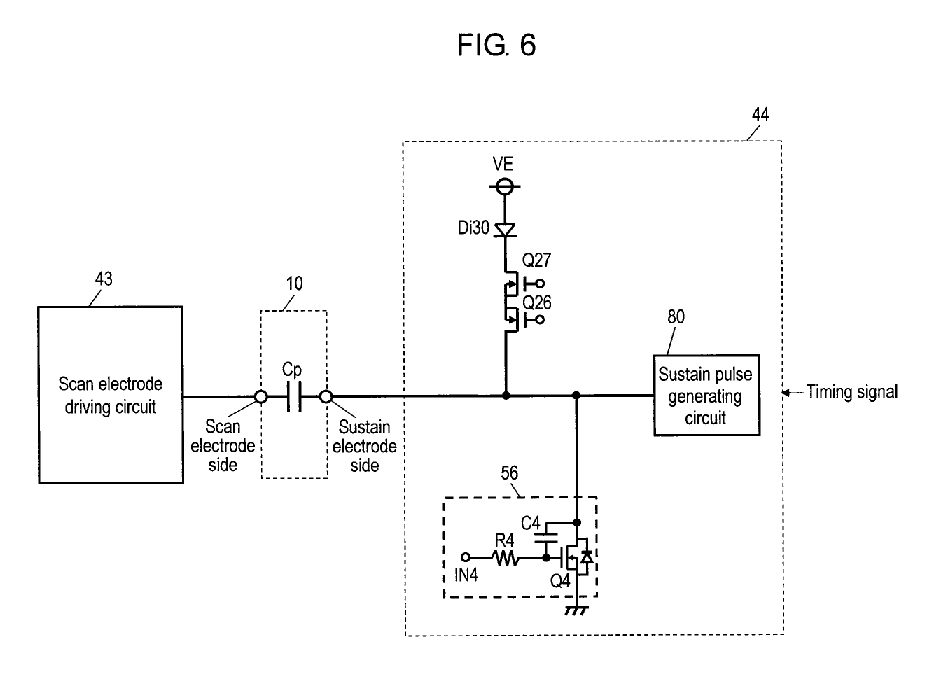

FIG. 6 is a circuit diagram showing a configuration example of sustains electrode driving circuit 44 of plasma display device 1 in accordance with the first exemplary embodiment of the present invention. In FIG. 6, the interelectrode capacitance of panel 10 is shown as Cp and the circuit diagram of scan electrode driving circuit 43 is omitted.

Sustain electrode driving circuit 44 has sustain pulse generating circuit 80 substantially identical in configuration to sustain pulse generating circuit 50, and is connected to sustain electrode SU1 through sustain electrode SUn of panel 10. Sustain pulse generating circuit 80 generates sustain pulses by switching the respective switching elements included therein in response to the timing signals output from timing generating circuit 45. In FIG. 6, the details of the paths of the timing signals are omitted.

Sustain electrode driving circuit 44 has the following elements:
power supply VE for generating voltage ye;
switching element Q26 and switching element Q27 for applying voltage Ve to sustain electrode SU1 through sustain electrode SUn; and
blocking diode Di30.

Sustain electrode driving circuit 44 also has Miller integrating circuit 56, i.e. a ramp voltage generating circuit for generating a falling ramp voltage. FIG. 6 shows the input terminal of Miller integrating circuit 56 as input terminal IN4. Miller integrating circuit 56 has switching element Q4, capacitor C4, and resistor R4.

In response to the timing signals, sustain electrode driving circuit 44 applies voltage Ve as the first voltage to sustain electrode SU1 through sustain electrode SUn by setting switching element Q26 and switching element Q27 to ON in the period during which a scan pulse is applied to scan electrode SC1 through scan electrode SCn.

After the application of a scan pulse to all scan electrode SC1 through scan electrode SCn is completed, switching element Q26 and switching element Q27 are set to OFF, and input terminal IN4 of Miller integrating circuit 56 is set to “Hi”. Specifically, a predetermined constant current is input to input terminal IN4. At this time, the constant current to be input to input terminal IN4 is generated such that the gradient of the ramp voltage is at a desired value (e.g. −2.5 V/μsec). Then, the constant current flows toward capacitor C4, the drain voltage of switching element Q4 starts to fall in a ramp form, and the voltage of sustain electrode SU1 through sustain electrode SUn starts to fall from voltage Ve toward the ground potential as the base potential in a ramp form (with a gradient of −2.5 V/μsec, for example). Input terminal IN4 is kept at “Hi” until the voltage of sustain electrode SU1 through sustain electrode SUn reaches the ground potential so that this voltage drop is continued. In this exemplary embodiment, down-ramp voltage L5 is generated in this manner.

The configuration for generating down-ramp voltage L5 is not limited to the configuration of FIG. 6. Any configuration can be used as long as the voltage applied to sustain electrode SU1 through sustain electrode SUn can be dropped with a desired gradient in a ramp form.

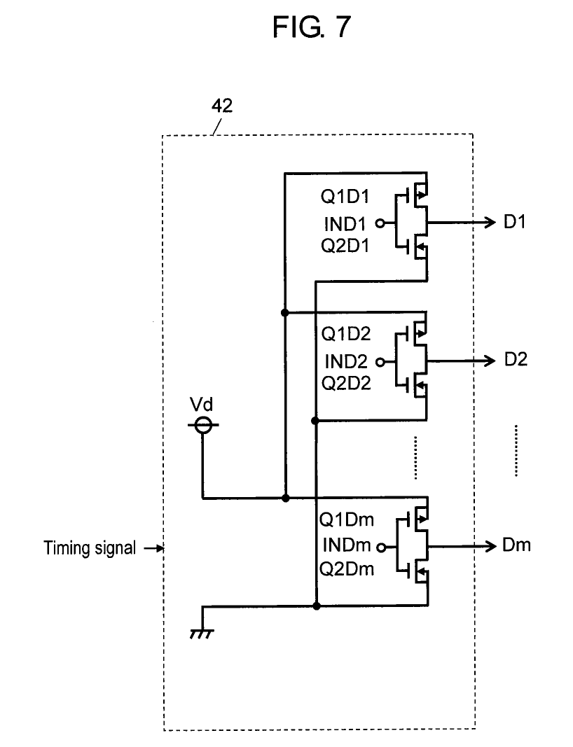

FIG. 7 is a circuit diagram showing a configuration example of data electrode driving circuit 42 of plasma display device 1 in accordance with the first exemplary embodiment of the present invention.

Data electrode driving circuit 42 has switching element Q1D1 through switching element Q1Dm and switching element Q2D1 through switching element Q2Dm. One terminal of switching element Q1Dg (g being 1 through m) is interconnected to one terminal of switching element Q2Dg. The interconnected part forms an output terminal of data electrode driving circuit 42 and is connected to data electrode Dg. The other terminal of switching element Q1Dg is connected to power supply VD for generating voltage Vd; the other terminal of switching element Q2Dg is connected to the ground potential. FIG. 7 shows the input terminal common to switching element Q1Dg and switching element Q2Dg as terminal INDg. In FIG. 7, the details of the paths of the timing signals are omitted.

In the address periods, in response to the timing signals, data electrode driving circuit 42 applies address pulse voltage Vd to data electrode Dk by setting switching element Q1Dk to ON and switching element Q2Dk to OFF. In the period during which down-ramp voltage L5 is applied to sustain electrode SU1 through sustain electrode SUn, the data electrode driving circuit applies voltage Vd to data electrode D1 through data electrode Dn by setting switching element Q1D1 through switching element Q1Dm to ON and switching element Q2D1 through switching element Q2Dm to OFF.

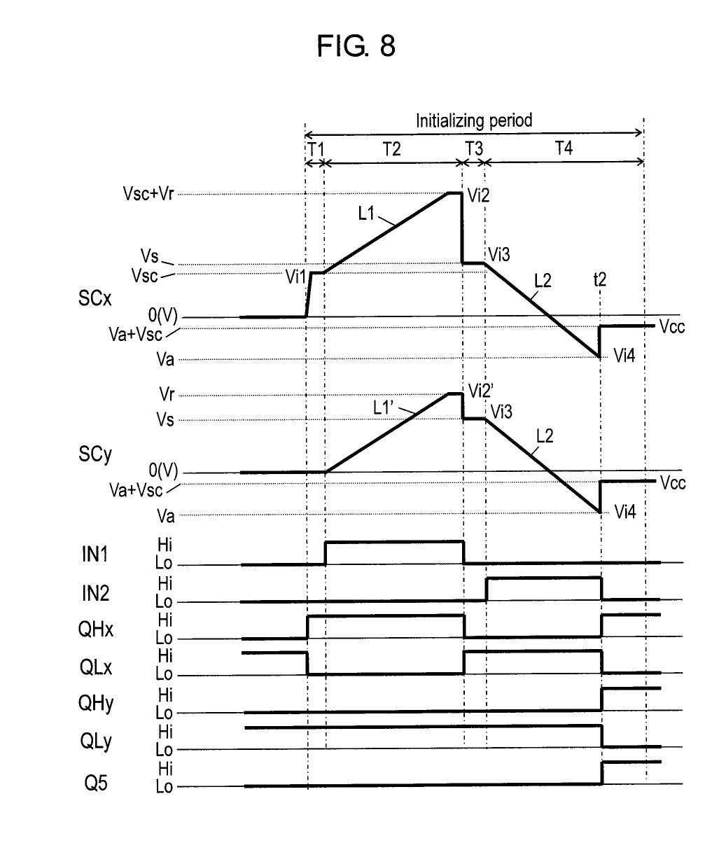

Next, with reference to FIG. 8, a description is provided for the operation of generating a forced initializing waveform and a non-initializing waveform in the initializing period of a specified-cell initializing subfield.

FIG. 8 is a timing chart for explaining an example of the operation of scan electrode driving circuit 43 in the initializing period of a specified-cell initializing subfield in accordance with the first exemplary embodiment of the present invention. In this chart, scan electrode 22 to be applied with a forced initializing waveform is denoted as “scan electrode SCx”, and scan electrode 22 to be applied with a non-initializing waveform as “scan electrode SCy”.

The description of the operation of scan electrode driving circuit 43 when a selective initializing waveform is generated in a selective initializing subfield is omitted. However, the operation of generating down-ramp voltage L4, i.e. a selective initializing waveform, is the same as the operation of generating down-ramp voltage L2 of FIG. 8. The non-initializing operation in a non-initializing subfield is the operation of generating and applying a non-initializing waveform to all scan electrodes 22 in the initializing period. Thus, the description of the operation of scan electrode driving circuit 43 in the initializing period of a non-initializing subfield is also omitted.

With reference to FIG. 8, the initializing period is divided into four sub-periods shown by sub-period T1 through sub-period T4, and each sub-period is described. In the following description, voltage Vi1 is equal to voltage Vsc, voltage Vi2 is equal to voltage Vsc+voltage Vr, voltage Vi2′ is equal to voltage Vr, voltage Vi3 is equal to voltage Vs used to generate sustain pulses, and voltage Vi4 is equal to negative voltage Va. In the chart, a signal for setting a switching element to ON is denoted as “Hi”, and a signal for setting a switching element to OFF as “Lo”.

FIG. 8 shows an example where voltage Vs is set to a value higher than voltage Vsc. However, voltage Vs and voltage Vsc may be at an equal value, or voltage Vs may be lower than voltage Vsc.

First, before sub-period T1, the clamp circuit of sustain pulse generating circuit 50 is operated so as to set reference potential A to 0 (V). Next, switching element QH1 through switching element QHn are set to OFF and switching element QL1 through switching element QLn are set to ON so that reference potential A, i.e. 0 (V), is applied to scan electrode SC1 through scan electrode SCn.

### (Sub-Period T1)

In sub-period T1, switching element QHx connected to scan electrode SCx is set to ON, and switching element QLx connected thereto is set to OFF. Thereby, voltage Vc where voltage Vsc is superimposed on reference potential A (0 (V) at this time), i.e. voltage Vc=voltage Vsc, is applied to scan electrode SCx to be applied with a forced initializing waveform.

On the other hand, switching element QHy connected to scan electrode SCy is kept at OFF, and switching element QLy connected thereto is kept at ON. Thereby, reference potential A, i.e. 0 (V), is applied to scan electrode SCy to be applied with a non-initializing waveform.

### (Sub-Period T2)

In sub-period T2, switching element QH1 through switching element QHn, and switching element QL1 through switching element QLn are kept in a state the same as that in sub-period T1. That is, switching element QHx connected to scan electrode SCx is kept at ON, and switching element QLx connected thereto is kept at OFF. Switching element QHy connected to scan electrode SCy is kept at OFF, and switching element QLy connected thereto is kept at ON.

Next, input terminal IN1 of Miller integrating circuit 53 for generating up-ramp voltage L1′ is set to “Hi”. Specifically, a predetermined constant current is input to input terminal IN1. Then, the constant current flows toward capacitor C1, the source voltage of switching element Q1 rises in a ramp form, and reference potential A starts to rise from 0 (V) in a ramp form. This voltage rise can be continued in the period during which input terminal IN1 is set to “Hi” or until reference potential A reaches voltage Vr.

At this time, the constant current to be input to input terminal IN1 is generated such that the gradient of the ramp voltage is at a desired value (e.g. 0.5 V/μsec). In this manner, up-ramp voltage L1′, which rises from 0 (V) toward voltage Vi2′ (equal to voltage Vr in this exemplary embodiment), is generated.

Since switching element QHy is at OFF and switching element QLy is at ON, this up-ramp voltage L1′ is applied to scan electrode SCy without any change.

On the other hand, since switching element QHx is at ON and switching element QLx is at OFF, a voltage where voltage Vsc is superimposed on this up-ramp voltage L1′ is applied to scan electrode SCx. That is, the application voltage is up-ramp voltage L1, which rises from voltage Vi1 (equal to voltage Vsc in this exemplary embodiment) toward voltage Vi2 (equal to voltage Vsc+voltage Vr in this exemplary embodiment).

### (Sub-Period T3)

In sub-period T3, input terminal IN1 is set to “Lo”. Specifically, the input of the constant current to input terminal IN1 is stopped. Thus, the operation of Miller integrating circuit 53 is stopped. Switching element QH1 through switching element QHn are set to OFF and switching element QL1 through switching element QLn are set to ON, so that reference potential A is applied to scan electrode SC1 through scan electrode SCn. Further, the clamp circuit of sustain pulse generating circuit 50 is operated so as to set reference potential A to voltage Vs. Thereby, the voltage of scan electrode SC1 through scan electrode SCn falls to voltage Vi3 (equal to voltage Vs in this exemplary embodiment).

### (Sub-Period T4)

In sub-period T4, switching element QH1 through switching element QHn, and switching element QL1 through switching element QLn are kept in a state the same as that in sub-period T3.

Next, input terminal IN2 of Miller integrating circuit 54 for generating down-ramp voltage L2 is set to “Hi”. Specifically, a predetermined constant current is input to input terminal IN2. Thereby, the constant current flows toward capacitor C2, and the drain voltage of switching element Q2 starts to fall in a ramp form. The output voltage of scan electrode driving circuit 43 starts to fall toward negative voltage Vi4 in a ramp form. This voltage drop can be continued in the period during which input terminal IN2 is set to “Hi” or until reference potential A reaches voltage Va.

At this time, the constant current to be input to input terminal IN2 is generated such that the gradient of the ramp voltage is at a desired value (e.g. −0.5 V/μsec).

When the output voltage of scan electrode driving circuit 43 reaches negative voltage Vi4 (equal to voltage Va in this exemplary embodiment), input terminal IN2 is set to “Lo”. Specifically, the constant current input to input terminal IN2 is stopped. Thus, the operation of Miller integrating circuit 54 is stopped.

In this manner, down-ramp voltage L2, which falls from voltage Vi3 (equal to voltage Vs in this exemplary embodiment) toward negative voltage Vi4, is generated and applied to scan electrode SC1 through scan electrode SCn.

After the operation of Miller integrating circuit 54 is stopped by setting input terminal IN2 to “Lo”, switching element Q5 is set to ON so that reference potential A is at voltage Va. Further, switching element QH1 through switching element QHn are set to ON, and switching element QL1 through switching element QLn are set to OFF. Thereby, voltage Vc where voltage Vsc is superimposed on reference potential A, i.e. voltage Vcc (equal to voltage Va+voltage Vsc in this exemplary embodiment), is applied to scan electrode SC1 through scan electrode SCn, as preparation for the subsequent address period.

In this exemplary embodiment, a forced initializing waveform and a non-initializing waveform are generated in the initializing period of a specified-cell initializing subfield in this manner. By controlling switching element QH1 through switching element QHn and switching element QL1 through switching element QLn, the forced initializing waveform and the non-initializing waveform can be applied to scan electrodes 22 selectively. For example, the forced initializing waveform is applied to scan electrode SCx and the non-initializing waveform is applied to scan electrode SCy. Similarly, only the non-initializing waveform can be generated and applied to all scan electrodes 22 in the initializing period of a non-initializing subfield.

Each of down-ramp voltage L2 and down-ramp voltage L4 may be dropped to voltage Va as shown in FIG. 8. However, for example, the voltage drop may be stopped when the falling voltage reaches the voltage where voltage Vset2 is superimposed on voltage Va. Further, each of down-ramp voltage L2 and down-ramp voltage L4 may be raised immediately after having reached a preset voltage. However, for example, after the falling voltage has reached a preset low voltage, the voltage may be maintained for a certain period.

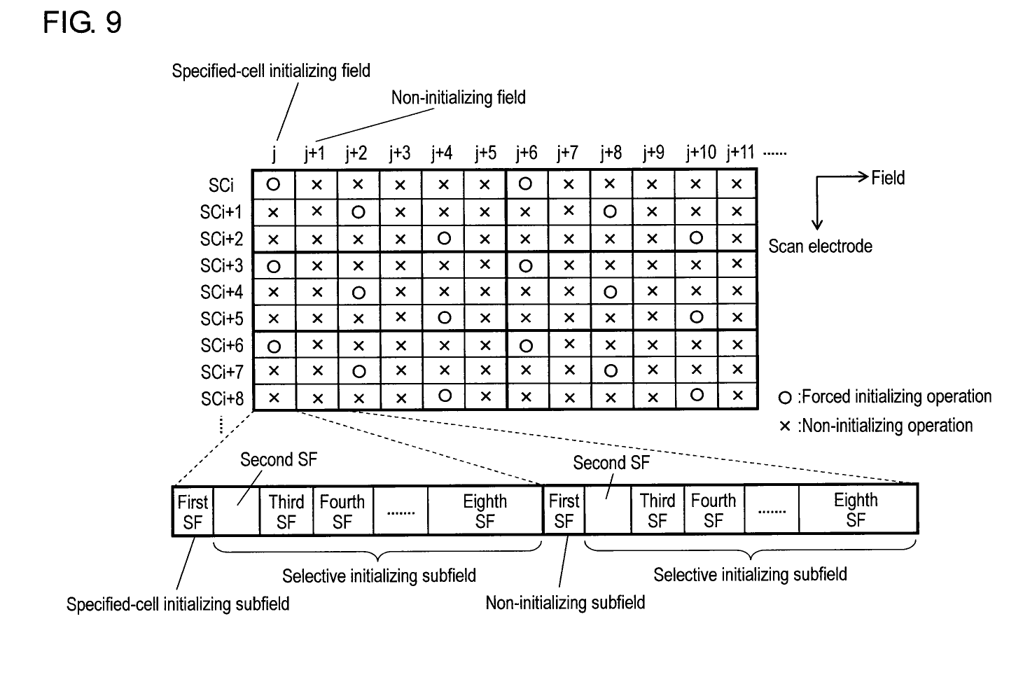

FIG. 9 is a chart showing an example of the pattern of forced initializing waveforms and non-initializing waveforms in accordance with the first exemplary embodiment of the present invention. FIG. 9 shows an example of the pattern of forced initializing waveforms and non-initializing waveforms generated when the frequency of forced initializing operations performed on each discharge cell is once every six fields. In FIG. 9, the horizontal axis shows fields, and the vertical axis shows scan electrodes 22. In the example of FIG. 9, the first SF is the above specified-cell initializing subfield or non-initializing subfield, and the remaining subfields (the second SF through the eighth SF) are the above selective initializing subfields.

The mark “o” in FIG. 9 shows that the forced initializing operation is performed in the initializing period of the first SF. That is, the forced initializing waveform having up-ramp voltage L1 and down-ramp voltage L2 shown in FIG. 8 is applied to scan electrodes 22. The mark “x” in FIG. 9 shows that the above non-initializing operation is performed in the initializing period of the first SF. That is, the non-initializing waveform having up-ramp voltage L1′ and down-ramp voltage L2 shown in FIG. 8 is applied to scan electrodes 22.

Hereinafter, a description is provided, using scan electrode SCi through scan electrode SCi+2 and j field through j+5 field, as an example.

First, in the first SF of j field, a forced initializing waveform is applied to scan electrode SCi, and a non-initializing waveform is applied to scan electrode SCi+1 and scan electrode SCi+2.

In the first SF of subsequent j+1 field, a non-initializing waveform is applied to all scan electrodes 22.

In the first SF of subsequent j+2 field, a forced initializing waveform is applied to scan electrode SCi+1, and a non-initializing waveform is applied to scan electrode SCi and scan electrode SCi+2.

In the first SF of subsequent j+3 field, a non-initializing waveform is applied to all scan electrodes 22.

In the first SF of subsequent j+4 field, a forced initializing waveform is applied to scan electrode SCi+2, and a non-initializing waveform is applied to scan electrode SCi and scan electrode SCi+1.

In the first SF of subsequent j+5 field, a non-initializing waveform is applied to all scan electrodes 22.

In this manner, one repetitive operation on scan electrode SCi through scan electrode SCi+2 is completed. In the other ones of scan electrodes 22, the operation the same as the above is performed. Also thereafter, the operation the same as the above is repeated in the respective fields. In the structure of FIG. 9, j field, j+2 field, and j+4 field, for example, are specified-cell initializing fields, and j+1 field, j+3 field, and j+5 field, for example, are non-initializing fields.

In this manner, in the example of FIG. 9, panel 10 is driven by the forced initializing waveforms and non-initializing waveforms selectively generated such that the number of forced initializing operations performed on each discharge cell is once every six fields. With this structure, the frequency of forced initializing operations performed on each discharge cell can be made lower than that in a structure where the forced initializing operation is performed on all the discharge cells every field. In the example of FIG. 9, the frequency can be reduced to one-sixth. Thus, the luminance of black level of the display image can be reduced.

The structure of FIG. 9 is a structure where the forced initializing waveforms are generated such that the number of scan electrodes 22 applied with the forced initializing waveforms is equal in the respective specified-cell initializing subfields. This structure can reduce fine flickering called “flicker” in the display image when compared with the following structure. For example, the flickers occur in a structure where a forced initializing operation is performed on all the discharge cells in one field out of six fields, and a non-initializing operation is performed on all the discharge cells in the remaining five fields.

Also in the structure where a forced initializing operation is performed on all the discharge cells in one field out of six fields, and a non-initializing operation is performed on all the discharge cells in the remaining five fields, the frequency of forced initializing operations in each discharge cell is once every six fields. However, in this structure, all the discharge cells in panel 10 emit light with the discharge caused by the forced initializing operation at a rate of once every six fields. Thus, for example, when an image to be updated in a cycle of 60 fields per second is displayed on panel 10, the luminance changes on the image display surface of panel 10 in a cycle of 10 fields per second. This cyclic change in luminance can be recognized by the user, as fine flickering, i.e. flickers, in the display image.

However, in this exemplary embodiment, the forced initializing waveforms are generated such that the number of scan electrodes 22 to be applied with the forced initializing waveforms is equal in the respective specified-cell initializing subfields. Thus, the initializing discharges caused by the forced initializing operations can be distributed to the respective fields. This can reduce the occurrence of flickers in the display image.

The above “such that . . . is equal” does not mean exactly equal, and means substantially “equal”. Slight variations are allowed.

As described above, in this exemplary embodiment, after the application of a scan pulse to all scan electrodes 22 is completed, the following operations are performed. Down-ramp voltage L5 that gently falls from positive voltage Ve as the first voltage to the ground potential as the base potential is applied to sustain electrodes 23. Further, in the period during which down-ramp voltage L5 is applied to sustain electrodes 23, positive voltage Vd as the second voltage is applied to data electrodes 32.

Even in the structure where, when a forced initializing operation is performed with the maximum voltage (voltage Vi2) of up-ramp voltage L1 lowered in order to reduce the luminance of black level, positive voltage Vd is applied to data electrodes 32 in order to cause an initializing discharge stably in the application of up-ramp voltage L1 to scan electrodes 22, the above method can prevent an unnecessary discharge in the discharge cells caused in the application of positive voltage Vd to data electrodes 32. Therefore, even in a structure where forced initializing operations are performed in each discharge cell at a frequency of once in a plurality of fields so as to further reduce the luminance of black level, the above method can prevent the occurrence of initializing bright spots and unlit cells and cause address discharge stably.

In this manner, when an initializing operation is performed with positive voltage applied to data electrodes 32, the operation in this exemplary embodiment can prevent the occurrence of an unnecessary discharge in the discharge cells and cause an address discharge stably, thus enhancing the image display quality in plasma display device 1.

In the present invention, the subfields forming a field are not limited to the above three types of subfields: a specified-cell initializing subfield; a non-initializing subfield; and a selective initializing subfield. For example, the following structure may also be used. That is, an all-cell initializing subfield where a forced initializing operation is performed on all the discharge cells in the initializing period is further set. In addition to the above two types of fields (a specified-cell initializing field and a non-initializing field), a new type of field (e.g. an all-cell initializing field where the first SF is an all-cell initializing subfield and the other subfields are selective initializing subfields) is set.

The pattern of forced initializing waveforms and non-initializing waveforms generated in the specified-cell initializing subfield in this exemplary embodiment only shows an example, and the present invention is not limited to such a structure. Any structure other than shown in this exemplary embodiment may be used as long as the structure can change the frequency of forced initializing waveforms.

The timing chart of FIG. 8 only shows an example in the exemplary embodiment of the present invention. The present invention is not limited to this timing chart.

### Second Exemplary Embodiment

In the first exemplary embodiment, down-ramp voltage L5 is shown as a waveform shape where the voltage falls with a fixed gradient. However, in the present invention, the down-ramp voltage is not limited to the waveform shape. For example, the down-ramp voltage may have a waveform shape that includes two ramps with gradients different from each other.

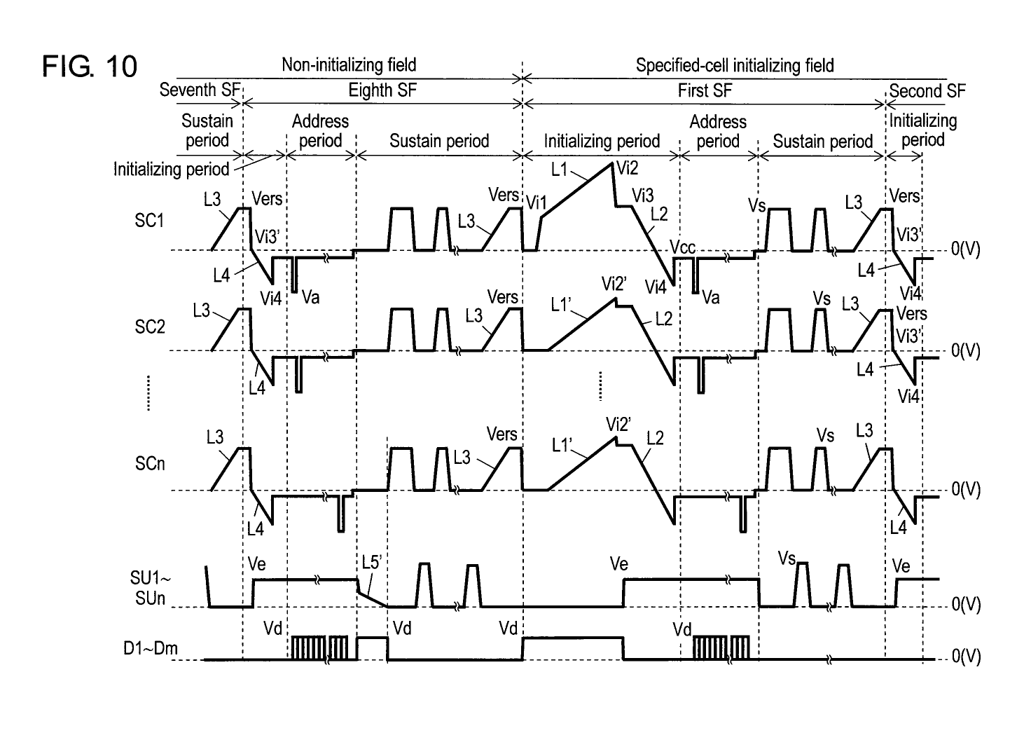

FIG. 10 is a waveform chart showing an example of driving voltage waveforms applied to the respective electrodes of panel 10 in accordance with the second exemplary embodiment of the present invention. The driving voltage waveforms of FIG. 10 are different from those of FIG. 3 in that down-ramp voltage L5′ in a waveform shape including two ramps with gradients different from each other is used instead of down-ramp voltage L5.

In this exemplary embodiment, down-ramp voltage L5′ to be applied to sustain electrodes 23 is generated in a waveform shape where the voltage falls steeply until the occurrence of a discharge in the discharge cells and falls gently after the occurrence of the discharge in the discharge cells. This structure can make the time taken to drive panel 10 shorter than that in the case of down-ramp voltage L5 while maintaining the advantage similar to that in the case of down-ramp voltage L5.

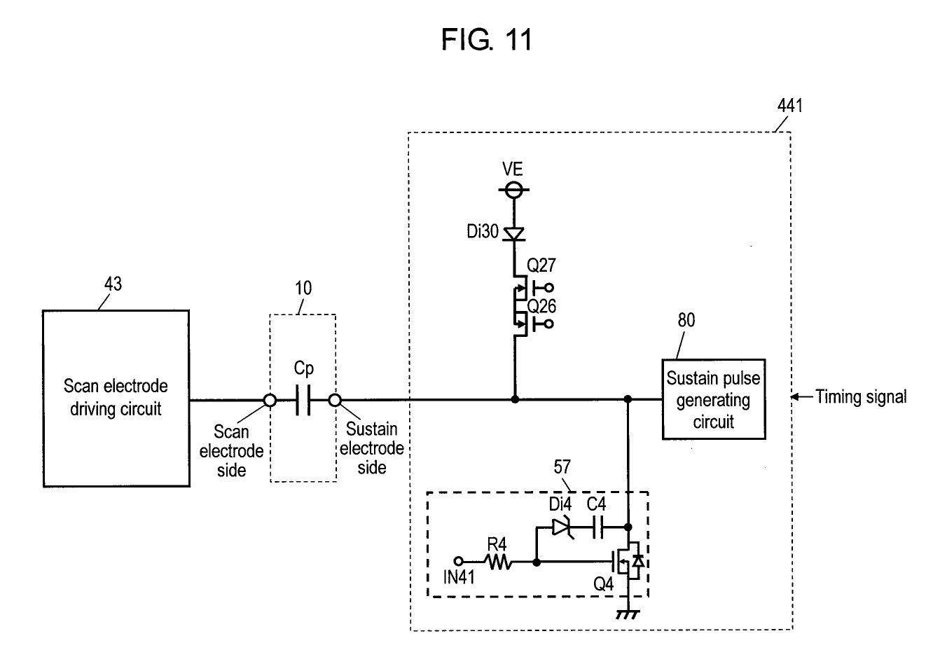

FIG. 11 is a circuit diagram showing a configuration example of sustain electrode driving circuit 441 of plasma display device 1 in accordance with the second exemplary embodiment of the present invention. In sustain electrode driving circuit 441 of FIG. 11, in order to generate down-ramp voltage L5′, a Miller integrating circuit for generating a falling ramp voltage has a configuration different from that of sustain electrode driving circuit 44 of FIG. 6.

As shown in FIG. 11, sustain electrode driving circuit 441 has Miller integrating circuit 57 for generating down-ramp voltage L5′. Miller integrating circuit 57 has switching element Q4, capacitor C4, and resistor R4 similar to those in Miller integrating circuit 56, and further has Zener diode Di4 series-connected to capacitor C4. In FIG. 11, the input terminal of Miller integrating circuit 57 is shown as input terminal IN41.

Zener diode Di4 is disposed in the forward direction of the constant current input from input terminal IN41 to Miller integrating circuit 57, and serves to steeply drop the voltage of sustain electrodes 23 by the Zener voltage (e.g. 80 (V)).

In this exemplary embodiment, the following operations are performed in a manner similar to the generation of down-ramp voltage L5 with Miller integrating circuit 56 of FIG. 6. That is, after the application of a scan pulse to all scan electrode SC1 through scan electrode SCn is completed, switching element Q26 and switching element Q27 are set to OFF, and input terminal IN41 of Miller integrating circuit 57 is set to “Hi” by imputing a predetermined constant current to input terminal IN41.

With this operation, the voltage of sustain electrodes 23 falls steeply by the Zener voltage of Zener diode Di4. At this time, the Zener voltage is set to a value slightly lower than the breakdown voltage. Thereby, the voltage applied to the discharge cells can be dropped steeply to a value at which a discharge almost occurs.

After the voltage of sustain electrodes 23 has steeply fallen by the Zener voltage, in a manner similar to the case of Miller integrating circuit 56, a constant current flows toward capacitor C4, the drain voltage of switching element Q4 starts to fall in a ramp form, and the voltage of sustain electrodes 23 starts to fall toward the ground potential as the base potential in a ramp form (with a gradient of −2.5 V/μsec, for example). In this exemplary embodiment, down-ramp voltage L5′ is generated in this manner.

As described above, in this exemplary embodiment, down-ramp voltage L5′ to be applied to sustain electrodes 23 are generated in a waveform shape where the voltage falls steeply until the occurrence of a discharge in the discharge cells and falls gently after the occurrence of the discharge in the discharge cells. This can make the time taken to drive panel 10 shorter than that in the case of down-ramp voltage L5.

The configuration for generating down-ramp voltage L5′ is not limited to the configuration of FIG. 11. Any configuration may be used as long as the voltage to be applied to sustain electrode SU1 through sustain electrode SUn can be generated in a waveform shape including two ramps with different gradients where the voltage falls with desired gradients.

In this exemplary embodiment, down-ramp voltage L5′ is shown as a waveform shape that includes two ramps with gradients different from each other. However, down-ramp voltage L5′ may have a waveform shape that includes three or more ramps having gradients different from each other.

### Third Exemplary Embodiment

In the first exemplary embodiment, a structure where a forced initializing operation is performed on each discharge cell once in a plurality of fields is used as an example, and a description is provided for the advantage of stabilizing the address operation in the discharge cells for undergoing no forced initializing operation. However, the present invention is not limited to this structure, and can be used in other subfield structures.

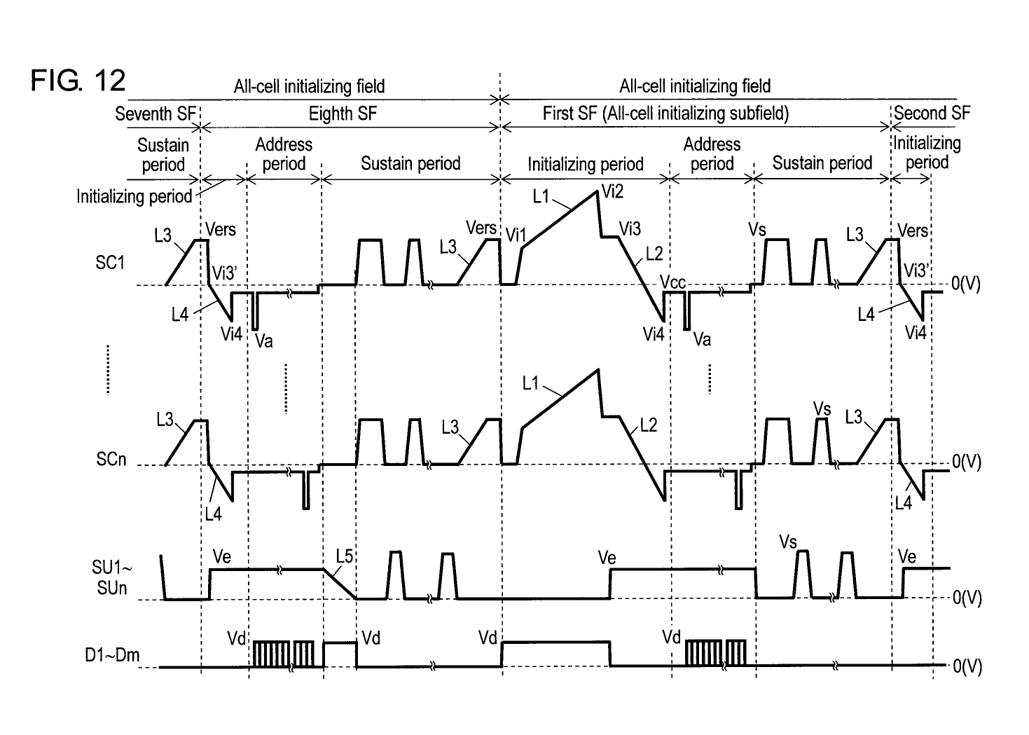

FIG. 12 is a waveform chart showing an example of driving voltage waveforms applied to the respective electrodes of panel 10 in accordance with the third exemplary embodiment of the present invention. In the driving voltage waveforms of FIG. 12, the first SF is an all-cell initializing subfield where a forced initializing operation is performed on all the discharge cells. Also in this case, an unnecessary discharge in the discharge cells caused in the application of positive voltage Vd to data electrodes 32 can be advantageously prevented so as to stabilize the forced initializing operation in the first SF.

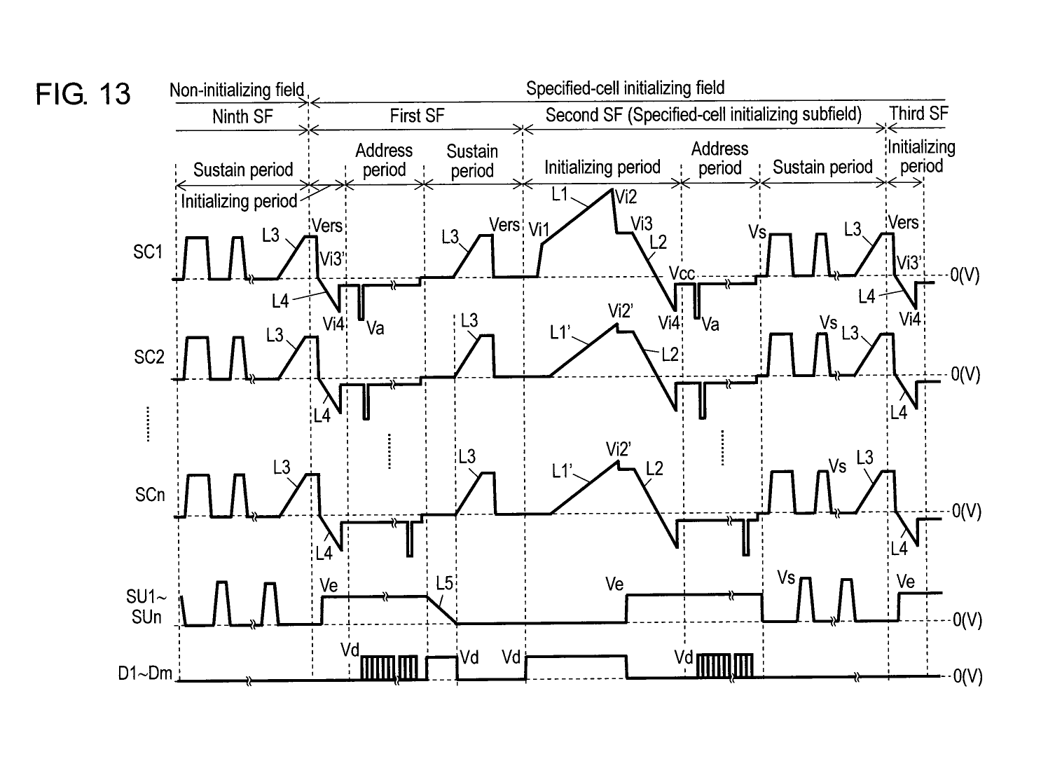

FIG. 13 is a waveform chart showing another example of driving voltage waveforms applied to the respective electrodes of panel 10 in accordance with the third exemplary embodiment of the present invention. In the driving voltage waveforms of FIG. 13, a specified-cell initializing field is structured such that the second SF is a specified-cell initializing subfield and the first SF and the third SF through the ninth SF are selective initializing subfields. In the sustain period of the first SF, no sustain pulses are generated and only erasing ramp voltage L3 is generated. Thereby, in this structure, the emission luminance is made lower than that of the light emission caused by sustain pulses, and a luminance weight smaller than a luminance weight of 1 (e.g. a luminance weight of 0.25) can be provided. That is, one field is formed of nine subfields (i.e. the first SF, the second SF through the ninth SF), and the respective subfields have luminance weights of 0.25, 1, 2, 4, 8, 16, 32, 64, and 128.

In a predetermined subfield, i.e. the first SF, which is the subfield immediately preceding the second SF where a forced initializing operation is performed by up-ramp voltage L1, down-ramp voltage L5 is generated so as to cause a weak discharge between sustain electrodes 23 and data electrodes 32. Also in this case, the occurrence of an unnecessary discharge in the discharge cells in the application of positive voltage Vd to data electrodes 32 can be prevented. This can prevent the occurrence of initializing bright spots and unlit cells, and cause address discharge stably.

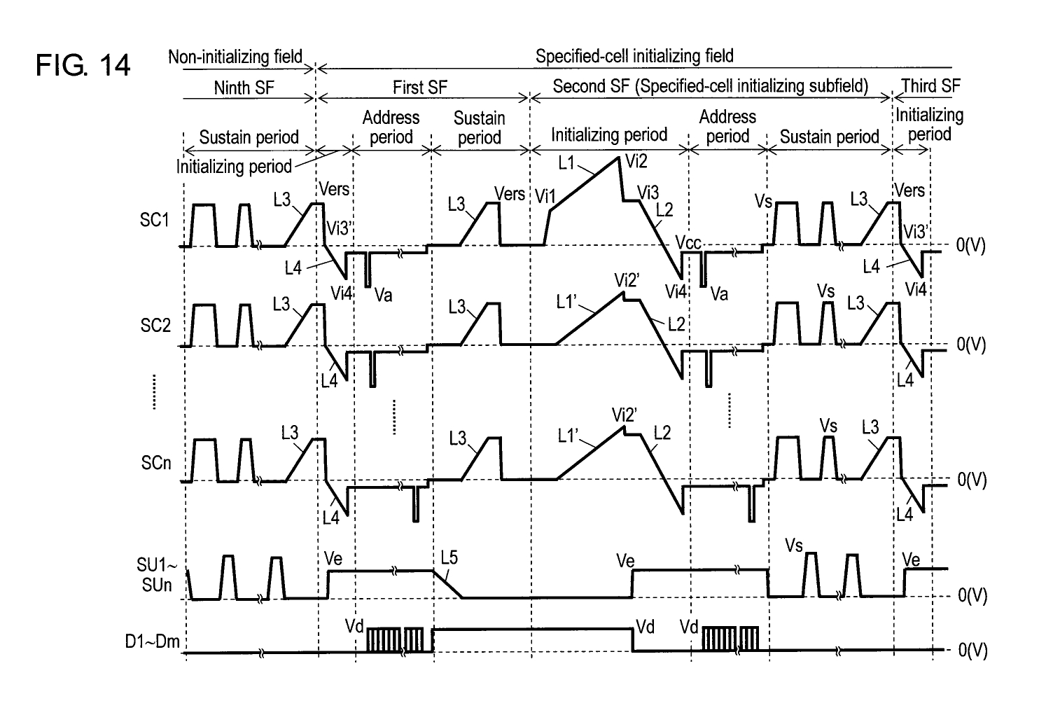

FIG. 14 is a waveform chart showing still another example of driving voltage waveforms applied to the respective electrodes of panel 10 in accordance with the third exemplary embodiment of the present invention. In the structure of the driving voltage waveforms of FIG. 14, in addition to the driving voltage waveforms of FIG. 13, positive voltage Vd is further applied to data electrodes 32 in the sustain period of the first SF, i.e. in the sustain period during which only erasing ramp voltage L3 is generated. Also in this case, the occurrence of an unnecessary discharge in the discharge cells in the application of positive voltage Vd to data electrodes 32 can be prevented. This can prevent the occurrence of initializing bright spots and unlit cells, and cause address discharge stably.

If the second voltage is applied to the data electrodes in the application of sustain pulses to the display electrode pairs in the sustain periods, a false discharge can be induced. Thus, in order to prevent such a false discharge, in the present invention, it is preferable to set the data electrodes to the base potential (ground potential), which is lower than voltage Vd as the second voltage, in the period during which sustain pulses are applied to the display electrode pairs.

In each of the structures described in these exemplary embodiments, down-ramp voltage L5 has a waveform shape where the voltage falls from the first voltage to the base potential. However, the present invention is not limited to this structure. Down-ramp voltage L5 may have a waveform shape where the voltage falls from the first voltage to a voltage lower than the first voltage at which a weak discharge can be caused in the discharge cells. The voltage may be higher than 0 (V) or lower than 0 (V).

The exemplary embodiments of the present invention can also be applied to a method for driving a panel by so-called two-phase driving. In the two-phase driving, scan electrode SC1 through scan electrode SCn are divided into a first scan electrode group and a second scan electrode group. Further, each address period is formed of two address periods: a first address period where a scan pulse is applied to each scan electrode belonging to the first scan electrode group; and a second address period where the scan pulse is applied to each scan electrode belonging to the second scan electrode group.

The exemplary embodiments of the present invention are also effective in a panel having an electrode structure where a scan electrode is adjacent to a scan electrode and a sustain electrode is adjacent to a sustain electrode. In this electrode structure, the electrodes are arranged on the front plate in the following order: a scan electrode, a scan electrode, a sustain electrode, a sustain electrode, a scan electrode, a scan electrode, or the like.

The specific numerical values in the exemplary embodiments of the present invention, e.g. the gradients of up-ramp voltage L1, down-ramp voltage L2, erasing ramp voltage L3, down-ramp voltage L5, and down-ramp voltage L5′, are based on the characteristics of a 50-inch panel having 1080 display electrode pairs, and only show examples in the exemplary embodiments. The present invention is not limited to these numerical values. Preferably, numerical values are set optimally for the characteristics of the panel, the specifications of the plasma display device, or the like. For each of these numerical values, variations are allowed within the range where the above advantages can be obtained.

### INDUSTRIAL APPLICABILITY

The present invention can prevent an unnecessary discharge in the discharge cells caused when an initializing operation is performed with a positive voltage applied to the data electrodes. This can reduce the luminance of black level in a display image and stabilize the address discharge at the same time, thus enhancing the image display quality. Therefore, the present invention is useful as a driving method for a panel, and a plasma display device.

### REFERENCE SIGNS LIST

1 Plasma display device
10 Panel (Plasma display panel)
21 Front plate
22 Scan electrode
23 Sustain electrode
24 Display electrode pair
25, 33 Dielectric layer
26 Protective layer
31 Rear plate
32 Data electrode
34 Barrier rib
35 Phosphor layer
41 Image signal processing circuit
42 Data electrode driving circuit
43 Scan electrode driving circuit
44, 441 Sustain electrode driving circuit
45 Timing generating circuit
50, 80 Sustain pulse generating circuit
51 Initializing waveform generating circuit
52 Scan pulse generating circuit
53, 54, 55, 56, 57 Miller integrating circuit
Q1, Q2, Q3, Q4, Q5, Q6, Q7, Q26, Q27, QH1 through QHn, QL1 through
QLn, Q1D1 through Q1Dm, Q2D1 through Q2Dm Switching element
C1, C2, C3, C4, C31 Capacitor
Di30, Di31 Diode
Di4 Zener diode
R1, R2, R3, R4 Resistor
L1 Up-ramp voltage
L2, L4, L5, L5′ Down-ramp voltage
L3 Erasing ramp voltage

1. A driving method for a plasma display panel,
the plasma display panel having a plurality of discharge cells, each of the discharge cells having a display electrode pair and a data electrode, the display electrode pair having a scan electrode and a sustain electrode,
the plasma display panel displaying gradation in a manner such that a plurality of subfields is set in one field and each of the subfields has an initializing period, an address period, and a sustain period,
in the initializing period, an initializing waveform being applied to the scan electrodes so as to cause an initializing discharge in the discharge cells,
in the address period, a scan pulse being applied to the scan electrodes, a first voltage being applied to the sustain electrodes, and an address pulse being selectively applied to the data electrodes so as to cause an address discharge in the discharge cells to be lit,
in the sustain period, sustain pulses being alternately applied to the display electrode pairs so as to cause a sustain discharge in the discharge cells having undergone the address discharge,
the driving method comprising:
applying a ramp voltage gently falling from the first voltage to the sustain electrodes in a predetermined one of the subfields, after application of the scan pulse to all the scan electrodes is completed and before the sustain pulses are applied to the display electrode pairs; and
applying a second voltage to the data electrodes in a period during which the falling ramp voltage is applied to the sustain electrodes.

2. The driving method for the plasma display panel of claim 1, wherein the falling ramp voltage has at least two ramps having gradients different from each other.

3. The driving method for the plasma display panel of claim 1, wherein
in the initializing period, any one of a plurality of initializing operations is selectively performed, the plurality of initializing operations including a forced initializing operation for causing the initializing discharge in the discharge cells by applying a forced initializing waveform to the scan electrodes, and
the predetermined subfield is one of the subfields immediately preceding another one of the subfields where the forced initializing operation is performed on some of the discharge cells in the initializing period.

4. The driving method for the plasma display panel of claim 3, wherein
the forced initializing operation is performed by applying a gently rising ramp voltage to the scan electrodes, and
in a period during which the rising ramp voltage is applied to the scan electrodes, a third voltage is applied to the data electrodes.

5. The driving method for the plasma display panel of claim 1, wherein in a period during which the sustain pulses are applied to the display electrode pairs, the data electrodes are at a base potential lower than the second voltage.

6. A plasma display device comprising:
a plasma display panel,
the plasma display panel being driven by a subfield method for gradation display in which a plurality of subfields are set in one field, and each of the subfields has an initializing period, an address period, and a sustain period,
the plasma display panel having a plurality of discharge cells, each of the discharge cells having a display electrode pair and a data electrode, the display electrode pair having a scan electrode and a sustain electrode;
a scan electrode driving circuit for applying an initializing waveform to the scan electrodes in the initializing period, for applying a scan pulse to the scan electrodes in the address period, and for applying sustain pulses to the scan electrodes in the sustain period, the initializing waveform causing an initializing discharge in the discharge cells;
a sustain electrode driving circuit for applying a first voltage to the sustain electrodes in the address period, and for applying sustain pulses to the sustain electrodes in the sustain period; and
a data electrode driving circuit for selectively applying an address pulse to the data electrode's in the address period,
wherein, in a predetermined one of the subfields, after the scan electrode driving circuit has completed application of the scan pulse to all the scan electrodes and before the scan electrode driving circuit or the sustain electrode driving circuit applies the sustain pulses to the display electrode pairs, the sustain electrode driving circuit applies a ramp voltage gently falling from the first voltage to the sustain electrodes, and
in a period during which the sustain electrode driving circuit applies the falling ramp voltage to the sustain electrodes, the data electrode driving circuit applies a second voltage to the data electrodes.

7. The driving method for the plasma display panel of claim 2, wherein
in the initializing period, any one of a plurality of initializing operations is selectively performed, the plurality of initializing operations including a forced initializing operation for causing the initializing discharge in the discharge cells by applying a forced initializing waveform to the scan electrodes, and
the predetermined subfield is one of the subfields immediately preceding another one of the subfields where the forced initializing operation is performed on some of the discharge cells in the initializing period.
